(19) United States
(12) Patent Application Publication
(10) Pub. No.: US 2024/0288462 A1
(43) Pub. Date: Aug. 29, 2024

(54) Reagent Cartridges and Related Systems and Methods

(71) Applicant: ILLUMINA, INC., San Diego, CA (US)

(72) Inventors: James Osmus, San Diego, CA (US); Hao Yu, Singapore (SG); Shih-Chung Wei, Singapore (SG); Jian En Koh, San Diego, CA (US)

(21) Appl. No.: 18/572,188

(22) PCT Filed: Mar. 17, 2023
(86) PCT No.: PCT/US2023/015515

§ 371 Date: Dec. 20, 2023

Related U.S. Application Data
(60) Provisional application No. 63/321,362, filed on Mar. 18, 2022.

(51) Int. Cl. G01N 35/10; G01N 35/00

(52) U.S. Cl. CPC G01N 35/1002; G01N 35/00871; G01N 2035/00544; G01N 2035/0091

(57) ABSTRACT

Reagent cartridges and related systems and methods are disclosed. In accordance with an implementation, an apparatus includes a first flexible container, a second flexible container, and a coupling. The first flexible container has an end and defines a first interior containing reagent. The second flexible container has an end and defines a second interior. The first flexible container is positioned within the second interior. The coupling has a first portion coupled to the end of the first flexible container and a second portion coupled to the end of the second flexible container. The coupling has a reagent port fluidly coupled to the first interior of the first flexible container and a pressure port fluidly coupled to the second interior of the second flexible container.

### RELATED APPLICATION

This application claims the benefit of and priority to U.S. Provisional Patent Application No. 63/321,362, filed Mar. 18, 2022, the content of which is incorporated by reference herein in its entirety and for all purposes.

### BACKGROUND

Reagent cartridges may be used with, for example, sequencing platforms. The sequencing platforms may include syringe pumps that flow reagent from the reagent cartridges.

### SUMMARY

Shortcomings of the prior art can be overcome and advantages and benefits as described later in this disclosure can be achieved through the provision of reagent cartridges and related systems and methods. Various implementations of the apparatus and methods are described below, and the apparatus and methods, including and excluding the additional implementations enumerated below, in any combination (provided these combinations are not inconsistent), may overcome these shortcomings and achieve the advantages and benefits described herein.

In accordance with a first implementation, an apparatus includes a reagent cartridge receptacle, a pressure source, and a reagent cartridge interface having a reagent coupling and a pressure coupling fluidly coupled to the pressure source. The apparatus also includes a reagent cartridge having a first flexible container, a second flexible container, and a coupling. The first flexible container has an end and defines a first interior containing reagent. The second flexible container has an end and defines a second interior. The first flexible container is positioned within the second interior. The coupling has a first portion coupled to the end of the first flexible container and a second portion coupled to the end of the second flexible container. The coupling has a reagent port fluidly coupled to the first interior of the first flexible container and a pressure port fluidly coupled to the second interior of the second flexible container. The reagent coupling is to couple with the reagent port to enable reagent to flow out of the first flexible container to the reagent coupling of the reagent cartridge interface and the pressure coupling is to couple with the pressure port to enable the pressure source to change a pressure within the second flexible container to urge the reagent to flow out of the first flexible container.

In accordance with a second implementation, an apparatus includes a first flexible container, a second flexible container, and a coupling. The first flexible container has an end and defines a first interior containing reagent. The second flexible container has an end and defines a second interior. The first flexible container is positioned within the second interior. The coupling has a first portion coupled to the end of the first flexible container and a second portion coupled to the end of the second flexible container. The coupling has a reagent port fluidly coupled to the first interior of the first flexible container and a pressure port fluidly coupled to the second interior of the second flexible container.

In accordance with a third implementation, a method includes depositing reagent within a first flexible container having an end and defining a first interior and coupling a first portion of a coupling to the end of the first flexible container. The coupling has a reagent port fluidly coupled to the first interior of the first flexible container and a pressure port. The method also includes positioning the first flexible container within a second flexible container having an end and defining a second interior and coupling a second portion of the coupling to the end of the second flexible container. The pressure port fluidly coupled to the second interior of the second flexible container.

In accordance with a fourth implementation, a method includes coupling a reagent coupling of a reagent cartridge interface with a reagent port of a coupling of a reagent cartridge. The reagent cartridge has a first flexible container, a second flexible container, and the coupling. The first flexible container had an end and defines a first interior containing reagent. The second flexible container has an end and defines a second interior. The first flexible container is positioned within the second interior and the coupling is coupled to the end of the first flexible container and the end of the second flexible container. The method includes coupling a pressure coupling of the reagent cartridge interface with a pressure port of the coupling of the reagent cartridge, changing a pressure within the second flexible container, and urging the reagent to flow out of the first flexible container based on the change in the pressure.

In accordance with fifth implementation, an apparatus includes a system, comprising: a reservoir receptacle to receive a reservoir; a fluidic interface to be fluidly coupled to the reagent reservoir; and a pump fluidly coupled to the fluidic interface. The pump includes a housing including a pressure port and a flexible container disposed in the housing and including an inlet and an outlet. Each of the inlet and the outlet is externally accessible outside of the housing. The inlet is fluidly coupled to the fluidic interface. The system also includes a pressure source coupled with the pressure port and in fluid communication with the housing, and a flow cell receptacle to receive a flow cell and comprising a flow cell interface fluidly coupled to the outlet of the flexible container. Fluid is to flow from the reservoir to the inlet of the flexible container and the pressure source is to pressurize the housing and urge the fluid out of the outlet of the flexible container toward the flow cell receptacle.

In accordance with a sixth implementation, an apparatus includes a pump including a housing and a flexible container. The housing includes a pressure port and the flexible container is disposed in the housing and includes an inlet and an outlet. Each of the inlet and the outlet is externally accessible outside of the housing. Fluid is to flow from a reservoir to the inlet of the flexible container and the housing is to be pressurized to urge the fluid out of the outlet of the flexible container.

In accordance with a seventh implementation, an apparatus includes a pump including a housing defining a chamber; a flexible container having a first portion and a second portion and including an inlet and an outlet. The first portion and second portion are in fluid communication. Each of the inlet and the outlet is externally accessible outside of the housing. The pump includes a first actuator disposed in the housing and that is actuatable to act on the first portion of the flexible container; and a second actuator actuatable to act on the second portion of the flexible container. The flexible container, the first actuator, and the second actuator being disposed in the chamber. When the first actuator is actuated and the flexible container contains a first fluid and a second fluid, at least a portion of the first fluid and at least a portion of the second fluid is urged from the first portion of the flexible container to the second portion of the flexible container. When the second actuator is actuated and the flexible container contains a first fluid and a second fluid, at least a portion of the first fluid and at least a portion of the second fluid is urged from the second portion of the flexible container to the first portion of the flexible container.

In an eighth implementation, an apparatus includes a first flexible container including a pressure port and a second flexible container disposed in the first flexible container and including an aperture. The aperture is externally accessible outside of the pump. Fluid is to flow through the aperture to the second flexible container, and the first flexible container is to be pressurized to urge the fluid out through the aperture of the second flexible container.

In a ninth implementation, a method includes pumping fluid from a liquid reservoir to an inlet of a flexible container of a pump, the pump including: a housing; and the flexible container disposed in the housing and including the inlet and an outlet. The method also includes pressurizing the housing and urging the fluid out of the outlet of the flexible container toward a flow cell receptacle based the housing being pressurized.

In a tenth implementation, a method includes disposing a flexible container in a housing of a pump, the housing of the pump comprising an aperture and a pressure port and the flexible container disposed in the housing and including a coupling, an inlet, and an outlet. The method includes coupling the coupling of the flexible container to the aperture of the housing, and coupling a pressure source to the pressure port of the housing. The method includes filling the flexible container with a fluid, pressurizing the housing using the pressure source; and urging the fluid through the outlet of the flexible container, in response to the pressure source pressurizing the housing.

In an eleventh implementation, an apparatus includes a housing and a flexible container disposed in the housing and including an inlet and an outlet.

In further accordance with the foregoing first, second, third, fourth, fifth, sixth, seventh, eighth, ninth, tenth, and eleventh implementations, an apparatus and/or method may further include or comprise any one or more of the following:

In an implementation, the pressure source provides positive pressure.

In accordance another implementation, the pressure source provides negative pressure.

In accordance another implementation, the apparatus includes a seal carried by the reagent port and a seal carried by the pressure port. The reagent coupling sealingly engages the seal carried by the reagent port and the pressure coupling sealingly engages the seal carried by the pressure port.

In accordance another implementation, the reagent includes liquid reagent.

In accordance another implementation, the apparatus includes a cover covering the pressure port and the reagent port.

In accordance another implementation, the cover has an impermeable barrier.

In accordance another implementation, the cover includes foil.

In accordance another implementation, the reagent coupling pierces the cover covering the reagent port and the pressure coupling pierces the cover covering the pressure port.

In accordance another implementation, the coupling further includes an extension coupled to the reagent port and extends into the first interior of the first flexible container.

In accordance another implementation, the extension includes a tube having a proximal end coupled to the first portion of the coupling and a distal end disposed within the first interior of the first flexible container.

In accordance another implementation, the tube is coupled with the coupling by an interference fit.

In accordance another implementation, the apparatus includes an insert positioned within the second interior of the second flexible container and between the second flexible container and the first flexible container.

In accordance another implementation, the reagent coupling is received within the reagent port and the pressure coupling is received within the pressure port.

In accordance another implementation, the reagent coupling has a reagent conduit having a distal end received within the reagent port and the pressure coupling has a pressure conduit having a distal end received within the pressure port.

In accordance another implementation, the first flexible container has a first pouch bag and the second flexible container has a second pouch bag.

In accordance another implementation, the first flexible container has a neck and the first portion of the coupling is coupled to the neck of the first flexible container and the second flexible container has a neck and the second portion of the coupling is coupled to the neck of the second flexible container.

In accordance another implementation, the first flexible container includes a first material and the second flexible container includes a second material.

In accordance another implementation, the first material is resistant to air permeability.

In accordance another implementation, the first flexible container is metalized.

In accordance another implementation, the coupling includes a pressure fluidic line and a reagent fluidic line. The pressure fluidic line extends between the pressure port and the first portion of the coupling and the reagent fluidic line extends between the reagent port and the second portion of the coupling.

In accordance another implementation, the pressure fluidic line extends through the first portion of the coupling to enable a pressure within the second flexible container to change and the reagent fluidic line extends through the first portion and the second portion of the coupling to enable the reagent to flow out of the first flexible container.

In accordance another implementation, the coupling includes a fitment.

In accordance another implementation, the coupling further includes spacers that are positioned between the first portion and the second portion.

In accordance another implementation, the first portion of the coupling has opposing first side walls that form a first canoe shape and the second portion of the coupling has opposing second side walls that form a second canoe shape.

In accordance another implementation, the first canoe shape is smaller than the second canoe shape.

In accordance another implementation, the first side walls define slots and the second side walls define slots.

In accordance another implementation, the coupling has a head having the pressure port and the reagent port and the coupling further includes a neck positioned between the head and the second portion of the coupling.

In accordance another implementation, the apparatus includes a plate defining a slot. The neck of the coupling is positioned within the slot.

In accordance another implementation, the method includes positioning a seal within the reagent port and positioning a seal within the pressure port.

In accordance another implementation, the method includes covering the reagent port and the pressure port with a cover.

In accordance another implementation, the method includes coupling an extension to the reagent port.

In accordance another implementation, the extension has a tube.

In accordance another implementation, the extension extends into the first interior of the first flexible container after the first portion of the coupling is coupled to the end of the first flexible container.

In accordance with another implementation, the pressure source positively pressurizes the housing.

In accordance with another implementation, the pressure source positively pressurizes the housing to about 5 pounds per square inch (psi) gauge.

In accordance with another implementation, the pump comprises a coupling comprising the inlet and the outlet and the housing comprises an aperture through which the coupling extends to enable the inlet and the outlet to be externally accessible outside of the housing.

In accordance with another implementation, the coupling comprises a fitment.

In accordance with another implementation, the pump comprises a seal disposed between the coupling and the housing.

In accordance with another implementation, the housing comprises a pressure chamber in which the flexible container is disposed and the seal hermetically seals the pressure chamber.

In accordance with another implementation, the coupling comprises an extension and the flexible container has an interior that the extension extends into.

In accordance with another implementation, the extension comprises a tube.

In accordance with another implementation, the reservoir receptacle is to receive a second reservoir and the fluidic interface to be fluidly coupled to the second reservoir.

In accordance with another implementation, the apparatus further comprises a valve to selectively control fluid flow from the reservoir to the inlet of the flexible container and from the second reservoir to the inlet of the flexible container.

In accordance with another implementation, the valve comprises a three-way valve.

In accordance with another implementation, the apparatus further comprises a pair of second pumps, each pump corresponding to the reservoir or the second reservoir.

In accordance with another implementation, the second pumps are configured to dispense the fluid into the flexible container to enable jet mixing.

In accordance with another implementation, the fluid is a first fluid and the apparatus further includes a second fluid that jet-mixes with the first fluid.

In accordance with another implementation, the apparatus also includes a second pump to flow fluid from the reservoir to the flexible container.

In accordance with another implementation, the second pump is positioned downstream from the pump.

In accordance with another implementation, the second pump is positioned upstream of the pump.

In accordance with another implementation, the housing comprises a lower portion and an upper portion and wherein the inlet and the outlet of the flexible container extend through the lower portion.

In accordance with another implementation, the pump includes a coupling and the flexible container includes an end, the coupling coupling the end of the flexible container to the upper portion of the housing.

In accordance with another implementation, the coupling includes a strap.

In accordance with another implementation, the pump includes a first coupling comprising the inlet and a second coupling includes the outlet.

In accordance with another implementation, the housing includes a first end and a second end, the first coupling coupled at the first end of the housing and the second coupling coupled at the second end of the housing.

In accordance with another implementation, the apparatus further includes a first valve and a second valve. The first valve to control fluid flow into the inlet of the flexible container and the second valve to control fluid flow out of the second container.

In accordance with another implementation, the inlet of the flexible container has a plurality of openings.

In accordance with another implementation, the openings have central axes that are positioned about 45 degrees relative to one another.

In accordance with another implementation, the inlet of the flexible container is a converging nozzle.

In accordance with another implementation, the housing includes a body having a base, a sidewall, and a lid. The base and sidewall define a chamber and the lid encloses the chamber when disposed on the sidewall.

In accordance with another implementation, the base and the sidewall are integrally formed.

In accordance with another implementation, the housing further includes a gasket and the sidewall has an end. The gasket is disposed between the sidewall and the lid at the end of the side.

In accordance with another implementation, the lid is removably secured to the sidewall.

In accordance with another implementation, the housing further includes a plurality of fasteners to removably secure the lid to the sidewall.

In accordance with another implementation, the fasteners are disposed about a perimeter of the lid and the sidewall.

In accordance with another implementation, the base further includes a plurality of posts having ends that extend from the base and are disposed in the chamber. The lid including corresponding apertures that receive the ends of the posts.

In accordance with another implementation, the posts secure corners of the flexible container in the aperture disposed partially through the lid.

In accordance with another implementation, each of the plurality of posts includes a cylindrical seat extending from the base and having a first diameter and a pole extending from the cylindrical seat and having a second diameter. The first diameter is greater than the second diameter.

In accordance with another implementation, the housing includes a first coupling having a first nozzle and a second coupling having a second nozzle.

In accordance with another implementation, the first coupling is positioned opposite the second coupling.

In accordance with another implementation, the first nozzle is received in the inlet of the flexible container.

In accordance with another implementation, an interference fit is formed between the first nozzle and the inlet and the second nozzle and the outlet.

In accordance with another implementation, the housing is a first housing defining a first chamber, a first flexible container disposed in the first chamber; and the apparatus further comprising a second housing defining a second chamber, a second flexible container disposed in the second chamber.

In accordance with another implementation, a conduit fluidly couples the first flexible container and the second flexible container.

In accordance with another implementation, the first actuator positively pressurizes the first housing and the second actuator positively pressurizes the second housing.

In accordance with another implementation, the first flexible container is compressed when the first housing is pressurized, and the second flexible container is compressed when the second housing is pressurized.

In accordance with another implementation, the second actuator is not actuated when the first actuator is actuated, and the first actuator is not actuated when the second actuator is actuated.

In accordance with another implementation, the first actuator comprises a first flexible container and the second actuator comprises a second flexible container.

In accordance with another implementation, the first flexible container is inflatable to actuate the first flexible container and the second flexible container is inflatable to actuate the second flexible container.

In accordance with another implementation, the first portion of the flexible container is compressed when the first flexible container is inflated and the second portion of the flexible container is compressed when the second flexible container is inflated.

In accordance with another implementation, the apparatus further comprises an airtight seam hermetically sealing the first flexible container.

In accordance with another implementation, the airtight seam also hermetically seals the second flexible container and further couples the second flexible container to the first flexible container.

In accordance with another implementation, air wells are disposed between the first flexible container and the second flexible container.

In accordance with another implementation, the second flexible container is made of an oxygen barrier material.

In accordance with another implementation, the oxygen barrier material comprises aluminum or an aluminum alloy.

In accordance with another implementation, pressurizing the housing includes pressurizing the housing to about 5 pounds per square inch (psi) gauge.

In accordance with another implementation, the method further includes actuating an inlet valve from a closed configuration to an open configuration when pumping the fluid from the liquid reservoir to the inlet.

In accordance with another implementation, the method further includes actuating an outlet valve from a closed configuration to an open configuration when urging the fluid out of the outlet of the flexible container.

In accordance with another implementation, pumping the fluid from the liquid reservoir also includes pumping a first fluid from a first liquid reservoir and also pumping a second fluid from a second liquid reservoir to the inlet of the flexible container of the pump.

In accordance with another implementation, further including actuating a three-way valve between a first position fluidly coupling the first liquid reservoir with the flexible container and a second position fluidly coupling the second liquid reservoir with the flexible container.

In accordance with another implementation, the method includes jet mixing the first fluid and the second fluid in the flexible container.

In accordance with another implementation, further including a second pump comprising: a second housing having a pressure port; and a second flexible container disposed in the second housing and including an inlet and an outlet. The method includes filling at least one of the first flexible container and the second flexible container with the first fluid and the second fluid.

In accordance with another implementation, coupling the coupling of the flexible container to the aperture of the housing further includes securing an end of the flexible container to a coupling of the housing, wherein the end is disposed opposite the coupling of the flexible container and the coupling of the housing is disposed opposite the aperture of the housing.

In accordance with another implementation, coupling the coupling of the flexible container to the aperture of the housing also includes disposing a seal between the coupling and the aperture.

In accordance with another implementation, the housing of the pump has a base, a sidewall, and a lid, and wherein disposing the flexible container in the housing of the pump further comprises removably securing the lid to the sidewall of the housing.

In accordance with another implementation, the base of the housing also has a post extending from the base into an aperture disposed in the lid. And, disposing the flexible container in the housing of the pump includes securing the flexible container in the housing by the post urging a portion of the flexible container into the aperture disposed in the lid.

In accordance with another implementation, the housing includes a nozzle, and coupling the coupling of the flexible container to the aperture of the housing includes forming an interference fit between the outlet of the flexible container and the nozzle.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure.

FIG. 2 is a detailed cross-sectional view of a portion of an implementation of a reagent cartridge interface that can be used to implement the reagent cartridge interface of the system of FIG. 1 and a portion of a reagent cartridge that can be used to implement the reagent cartridge of FIG. 1.

FIG. 3 is a side view of an implementation of a reagent cartridge that can be used to implement the reagent cartridge of FIG. 1.

FIG. 4 is an isometric view of the coupling of the reagent cartridge of FIG. 3.

FIG. 5A is a detailed isometric cross-sectional view of the reagent cartridge of FIG. 3.

FIG. 5B is a detailed isometric cross-sectional view of a reagent cartridge that can be used to implement the reagent cartridge of FIG. 1.

FIG. 6 is an isometric view of a plurality of reagent cartridges of FIG. 3 that are coupled together using a plate.

FIG. 7 is a side view of a reagent cartridge that can be used to implement the reagent cartridge of FIG. 1.

FIG. 8 is a detailed cross-sectional view of a reagent cartridge that can be used to implement the reagent cartridge of FIG. 1.

FIG. 9 is a detailed cross-sectional view of a reagent cartridge that can be used to implement the reagent cartridge of FIG. 1.

FIG. 10 is a side view of a reagent cartridge that can be used to implement the reagent cartridge of FIG. 1.

FIG. 11 illustrates a flowchart for a method of assembling the reagent cartridges of FIGS. 1-10 or any of the disclosed implementations.

FIG. 12 illustrates a flow chart for a method of flowing reagent out of the reagent cartridges of FIGS. 1-10 or any of the disclosed implementations.

FIG. 13 illustrates a schematic diagram of an implementation of another system in accordance with the teachings of this disclosure.

FIG. 14 is a side view of an implementation of a pump that can be used to implement the pump of FIG. 13, with the pressure chamber of the housing being below a threshold pressure.

FIG. 15 is a side view of the pump of FIG. 14, with the pressure chamber of the housing being above a threshold pressure.

FIG. 16 is a side view of an implementation of a pump that can be used to implement the pump of FIG. 13, with the pressure chamber of the housing being below a threshold pressure.

FIG. 17 is a side view of the pump of FIG. 16, with the pressure chamber of the housing being above a threshold pressure.

FIG. 18 is a side view of an implementation of a pump that can be used to implement the pump of FIG. 13.

FIG. 19 is a side view of the pump of FIG. 18, with the pressure chamber of the housing being above a threshold pressure.

FIG. 20 illustrates the pump of FIG. 18 coupled with the pumps, and liquid reservoirs of FIG. 13.

FIG. 21 is a schematic view of an inlet that can be used to implement the inlet of any of the pumps disclosed herein.

FIG. 22 is a schematic view of another inlet that can be used to implement the inlet of any of the pumps disclosed.

FIG. 23 illustrates an expanded view of a pump that can be used to implement the pump of FIG. 18.

FIG. 24 is a perspective view of the pump of FIG. 23 including a flexible container.

FIG. 25 illustrates a flexible container that can be used to implement the flexible container of FIGS. 18, 19, and/or 23.

FIG. 26 illustrates a flexible container that can be used to implement the flexible container of FIGS. 14-17.

FIG. 27 is a side view of an implementation of a pump that can be used to implement the pump of FIG. 13.

FIG. 28 is a side view of the pump of FIG. 27, showing a second actuator actuated and urging at least a portion of first fluid and at least a portion of the second fluid from a second portion of the flexible container to a first portion of the flexible container.

FIG. 29A illustrates a side view of a pump that can be used to implement the pump of FIG. 13.

FIG. 29B illustrates a side view of a pump that can be used to implement the pump of FIG. 13 and is similar to the pump of FIG. 29A.

FIG. 30 illustrates a side view of a plurality of reagent reservoirs that can be used to implement the reagent cartridge of FIG. 1 and/or used to implement the pump of FIG. 13.

FIG. 31 illustrates a cross-sectional view of the reagent reservoirs of FIG. 30 containing a first threshold amount of fluid.

FIG. 32 illustrates a cross-sectional view of the reagent reservoirs of FIGS. 30 and 31 containing a second threshold amount of fluid.

### DETAILED DESCRIPTION

Although the following text discloses a detailed description of implementations of methods, apparatuses and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

The disclosed implementations relate to consumables and related systems that use a positive pressure source to urge fluid out of a flexible container. The flexible container may have a known volume and may refillable during one or more operations. The flexible container may alternatively be a consumable that is not refilled.

Dispensing the fluid out of a flexible container having a known volume may allow for the fluid to be accurately metered during the corresponding operations. An implementation of a system has a reservoir, a fluidic interface, and a pump. The pump is fluidly coupled to the reservoir through the fluidic interface. The pump includes a housing with a pressure port and a flexible container disposed in the housing. The flexible container of the pump includes an inlet and an outlet that are accessible outside of the housing. The flexible container receives fluid from the reservoir through the inlet, the housing is pressurized and expels the fluid from the flexible container through the outlet.

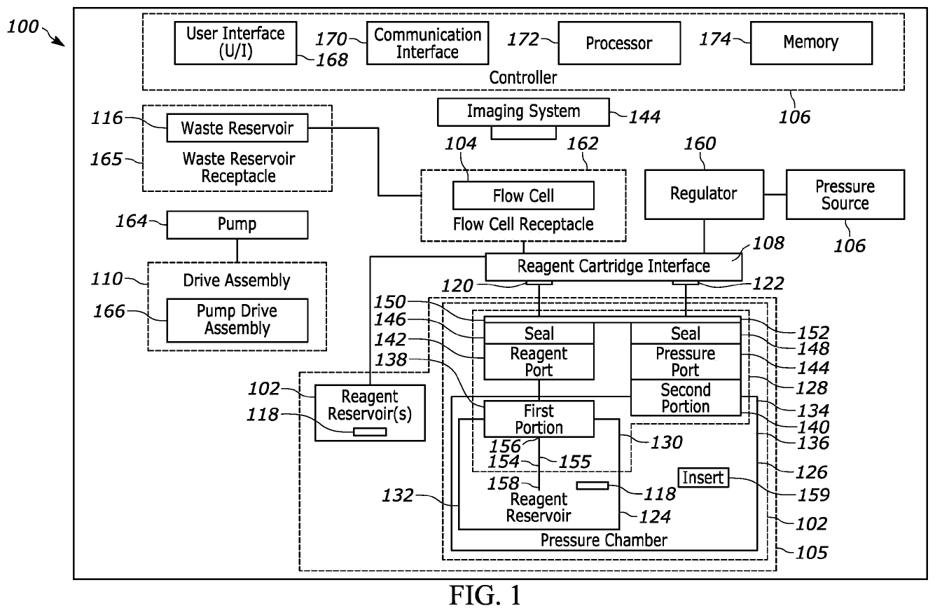

FIG. 1 illustrates a schematic diagram of an implementation of a system 100 in accordance with the teachings of this disclosure. The system 100 can be used to perform an analysis on one or more samples of interest. The sample may include one or more DNA clusters that are linearized to form a single stranded DNA (sstDNA). In the implementation shown, the system 100 receives a reagent cartridge 102 and a flow cell 104 and includes, in part, a reagent cartridge receptacle 105, a pressure source 106, a reagent cartridge interface 108, a drive assembly 110, a controller 112, an imaging system 114, and a waste reservoir 116. The reagent cartridge 102 may alternatively be referred to as a reagent assembly or a reagent reservoir. The reagent cartridge 102 contains reagent 118 in the implementation shown and the reagent cartridge receptacle 105 receives the reagent cartridge 102. The reagent 118 may be liquid reagent. The reagent cartridge interface 108 has a reagent coupling 120 and a pressure coupling 122 fluidly coupled to the pressure source 106. The controller 112 is electrically and/or communicatively coupled to the pressure source 106, the reagent cartridge interface 108, the drive assembly 110, and the imaging system 114 and causes the gas source 106, the reagent cartridge interface 108, the drive assembly 110, and/or the imaging system 114 to perform various functions as disclosed herein.

The flow cell 104 carries a sample of interest. The pressure source 106 may be used to pressurize the reagent cartridge 102 to flow the reagent 118 from the reagent cartridge 102 that interact with the sample. The pressure source 106 may be provided by the system 100 and/or may be carried by the reagent cartridge 102. Alternatively, the gas source 103 may be omitted.

A reversible terminator may be attached to the reagent 118 to allow a single nucleotide to be incorporated onto a growing DNA strand. One or more of the nucleotides has a unique fluorescent label that emits a color when excited in some implementations. The color (or absence thereof) is used to detect the corresponding nucleotide. The imaging system 114 excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by the system 100. The imaging system 114 may be a fluorescence spectrophotometer including an objective lens and/or a solid-state imaging device. The solid-state imaging device may include a charge coupled device (CCD) and/or a complementary metal oxide semiconductor (CMOS).

Another reaction component (e.g., a reagent) is flowed into the flow cell 104 after the image data is obtained that is thereafter received by the waste reservoir 109 and/or otherwise exhausted by the reagent cartridge 102. The reaction component may perform a flushing operation that chemically cleaves the fluorescent label and the reversible terminator from the sstDNA. The sstDNA is then ready for another cycle.

The reagent cartridge 102 has a first flexible container 124, a second flexible container 126, and a coupling 128. The first flexible container 124 may be referred to as a reagent reservoir and the second flexible container 126 may be referred to as a pressure chamber. The first flexible container 124 has an end 130 and defines an interior 132 that contains the reagent 118 and the second flexible container 126 also has an end 134 and defines an interior 136. The interior 132 may be referred to as a first interior and the interior 136 may be referred to as a second interior. The first flexible container 124 is positioned within the interior 136 of the second flexible container 126.

The coupling 128 has a first portion 138 coupled to the end 130 of the first flexible container 124 and a second portion 140 coupled to the end 134 of the second flexible container 126. The coupling 128 may be coupled to the first flexible container 124 and the second flexible container 126 using a heat sealing process. The coupling 128 also has a reagent port 142 fluidly coupled to the interior 132 of the first flexible container 124 and a pressure port 144 fluidly coupled to the interior 136 of the second flexible container 126. The reagent coupling 120 couples with the reagent port 142 in operation to enable the reagent 118 to flow out of the first flexible container 124 to the reagent coupling 120 of the reagent cartridge interface 108 and the pressure coupling 122 couples with the pressure port 144 to enable the pressure source 106 to change a pressure within the second flexible container 126 to urge the reagent 118 to flow out of the first flexible container 124. The pressure source 106 may provide positive pressure to the second flexible container 126 and/or the pressure source 106 may provide negative pressure to the second flexible container 126. The pressure source 106 changes a pressure within the second flexible container 126 and that pressure change compresses the first flexible container 124 and urges the reagent 118 out of the first flexible container 124 regardless of whether the pressure provided is a positive pressure or a negative pressure. The pressure within the second flexible container 126 may apply a relatively even force on the first flexible container 124. All, a majority, or most of the reagent 118 may be dispensed from the first flexible container 124 as a result and, thus, the reagent cartridges 102 disclosed have low amounts of dead volume.

A seal 146 is carried by the reagent port 142 and a seal 148 is carried by the pressure port 144. The seal 146 provides a fluid seal and the seal 148 provides a pressure seal. The reagent coupling 120 sealingly engages the seal 146 carried by the reagent port 142 and the pressure coupling 122 sealingly engages the seal 148 carried by the pressure port 144. The seals 146, 148 may be O-rings and/or may be include an elastomer.

The reagent cartridge 102 also includes a cover 150 that covers the reagent port 142 and the pressure port 144. The cover 150 may be an impermeable barrier 152 such as foil. The cover 150 retains the reagent 118 within the first flexible container 124 and/or prevents or inhibits ingress of moisture into the interior 132 of the first flexible container 124 and/or the interior 136 of the second flexible container 126. The cover 150 may be a pierceable or removable cover including thin metal foil, such as aluminum foil, or a thin plastic sheet(s), such as Saran™ wrap. The cover 150 may comprise or consist of other materials and/or other layering arrangements that substantially prevent moisture ingress. The cover 150 may be coupled to the insert reagent port 142 and the pressure port 144 by heat sealing, laser welding, ultrasonic welding, pressure-sensitive adhesive (PSA), or any other suitable method. The cover 150 may alternatively be omitted. A pierceable septum or resealing spring valve may be included in place of the cover 150, for example.

The system 100 may pierce the cover 150 or the cover 150 may be pierced by an individual prior to use. The reagent coupling 120 may pierce the cover 150 covering the reagent port 142 in implementations when the system 100 pierces the cover 150 and the pressure coupling 122 may pierce the cover 150 covering the pressure port 142. The reagent coupling 120 and/or the pressure coupling 122 may include a piercing member such as a conical protrusion that is used to pierce the cover 150 as and/or prior to the couplings being formed between the reagent coupling 120 and the reagent port 142 and between the pressure coupling 122 and the pressure port 144.

The coupling 128 includes an extension 154 in the implementation shown that is coupled to the reagent port 142 and extends into the interior 132 of the first flexible container 124. The extension 154 may be used to encourage more of the reagent 118 to flow out of the first flexible container 124 and, thus, for less dead volume to be left within the first flexible container 124 when emptied. The extension 154 may alternatively be omitted. The extension 154 may be a tube 155 having a proximal end 156 coupled to the first portion 138 of the coupling 128 and a distal end 158 disposed within the interior 132 of the first flexible container 124. The tube 155 may be referred to as a straw. The tube 155 may is coupled with the coupling 128 by an interference fit. The tube 155 may be coupled to the coupling 128 in other ways, however. Adhesive may be used to couple the tube 155 and the coupling 128, for example.

An insert 159 may be positioned within the interior 136 of the second flexible container 126 and positioned between the second flexible container 126 and the first flexible container 124. The insert 159 may be a structure and/or a mesh that allows the second flexible container 126 to slide and/or move relative to the first flexible container 124. Relative movement between the second flexible container 126 and the first flexible container 124 is helpful when the pressure source 106 applies negative pressure.

A regulator 160 can be positioned between the pressure source 106 and the reagent cartridge interface 108 and regulates a pressure provided to the reagent cartridge interface 108 and, thus, the second flexible container 126. The regulator 160 may alternatively not be included.

The reagent cartridge 102 is in fluid communication with the flow cell 104. A “flow cell” as used herein can include a device having a lid extending over a reaction structure to form a flow channel therebetween that is in communication with a plurality of reaction sites of the reaction structure, and can include a detection device that detects designated reactions that occur at or proximate to the reaction sites. The flow cell 104 is shown being received within a flow cell receptacle 162 of the system 100. The flow cell 104 may alternatively be carried by or otherwise integrated into the reagent cartridge 102.

While the above disclosure describes urging liquid and/or the reagent 118 into and out of the first flexible container 124 and/or through the flow cell 104 under positive pressure, liquid and/or the reagent 118 may alternatively be drawn through the flow cell 104 under negative pressure when, for example, the reagent cartridge(s) 102 is not pressurized. The system 100 may include a pump 164 positioned between the flow cell 104 and the waste reservoir 116 to do so. The waste reservoir 109 may be selectively receivable within a waste reservoir receptacle 165 of the system 100. The pump 164 may be implemented by a syringe pump, a peristaltic pump, a diaphragm pump, etc. While the pump 164 is shown being part of the system 100 and positioned between the flow cell 104 and the waste reservoir 1116 the pump 164 may be positioned upstream of the flow cell 104, may be part of the reagent cartridge 102, or omitted entirely, in other implementations.

Referring now to the drive assembly 110, in the implementation shown, the drive assembly 110 includes a pump drive assembly 166 that interfaces with the pump 164 to pump fluid through the reagent cartridge 102 and/or the flow cell 104.

The controller 112 includes a user interface 168, a communication interface 170, one or more processors 172, and a memory 174 storing instructions executable by the one or more processors 172 to perform various functions including the disclosed implementations. The user interface 168, the communication interface 170, and the memory 174 are electrically and/or communicatively coupled to the one or more processors 172.

In an implementation, the user interface 168 receives input from a user and provides information to the user associated with the operation of the system 100 and/or an analysis taking place. The user interface 168 may include a touch screen, a display, a key board, a speaker(s), a mouse, a track ball, and/or a voice recognition system. The touch screen and/or the display may display a graphical user interface (GUI).

In an implementation, the communication interface 170 enables communication between the system 100 and a remote system(s) (e.g., computers) via a network(s). The network(s) may include an intranet, a local-area network (LAN), a wide-area network (WAN), the intranet, etc. Some of the communications provided to the remote system may be associated with analysis results, imaging data, etc. generated or otherwise obtained by the system 100. Some of the communications provided to the system 100 may be associated with a fluidics analysis operation, patient records, and/or a protocol(s) to be executed by the system 100.

The one or more processors 172 and/or the system 100 may include one or more of a processor-based system(s) or a microprocessor-based system(s). In some implementations, the one or more processors 172 and/or the system 100 includes a reduced-instruction set computer(s) (RISC), an application specific integrated circuit(s) (ASICs), a field programmable gate array(s) (FPGAs), a field programmable logic device(s) (FPLD(s)), a logic circuit(s), and/or another logic-based device executing various functions including the ones described herein.

The memory 174 can include one or more of a hard disk drive, a flash memory, a read-only memory (ROM), erasable programmable read-only memory (EPROM), electrically erasable programmable read-only memory (EEPROM), a random-access memory (RAM), non-volatile RAM (NVRAM) memory, a compact disk (CD), a digital versatile disk (DVD), a cache, and/or any other storage device or storage disk in which information is stored for any duration (e.g., permanently, temporarily, for extended periods of time, for buffering, for caching).

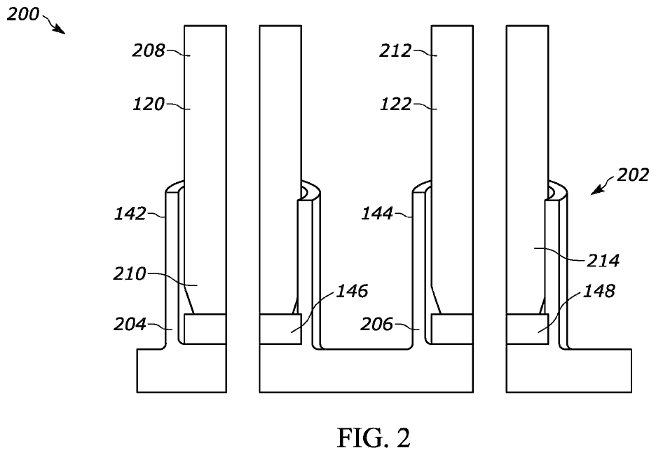

FIG. 2 is a detailed cross-sectional view of a portion of an implementation of a reagent cartridge interface 200 that can be used to implement the reagent cartridge interface 108 of the system 100 of FIG. 1 and a portion of a reagent cartridge 202 that can be used to implement the reagent cartridge 102 of FIG. 1. The reagent cartridge interface 200 includes the reagent coupling 120 and the pressure coupling 122 and the reagent cartridge 202 includes the reagent port 142 and the pressure port 144. The seals 146, 148 are positioned within the corresponding ports 142, 144.

The reagent coupling 120 is shown being received within the reagent port 142 and the pressure coupling 122 is shown being received within the pressure port 144. The reagent port 142 is formed of or comprises an annular wall 204 and the reagent port 142 is also formed of or comprises an annular wall 206. The reagent coupling 120 includes a reagent conduit 208 having a distal end 210 that is shown received within the reagent port 142 and the pressure coupling 122 similarly includes a pressure conduit 212 having a distal end 214 received within the pressure port 144.

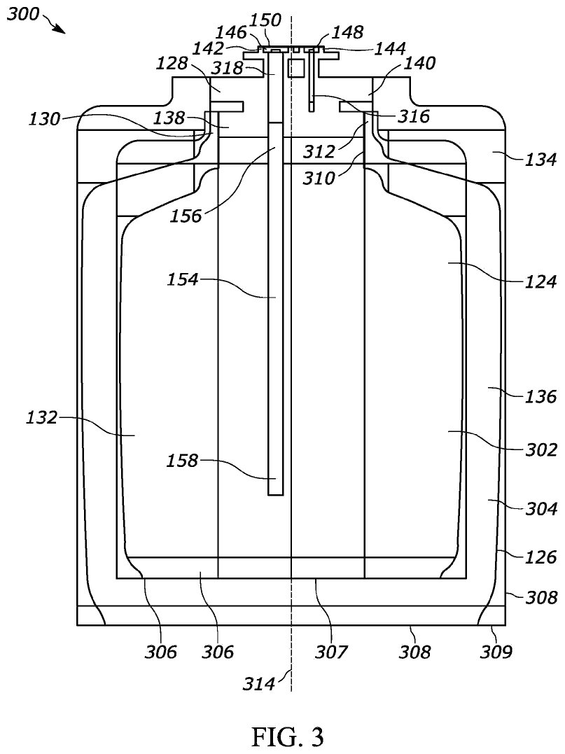

FIG. 3 is a side view of an implementation of a reagent cartridge 300 that can be used to implement the reagent cartridge 102 of FIG. 1. The reagent cartridge 300 includes the first flexible container 124, the second flexible container 126, and the coupling 128. The first flexible container 124 is a pouch bag 302 in the implementation shown and the second flexible container 126 is also a pouch bag 304. The pouch bag 302 is a 3-sided pouch having opposing side surfaces 306 and a base 307 and the pouch bag 304 is also shown as a 3-sided pouch having opposing side surfaces 308 and a base 309. The pouch bags 302, 304 may be differently configured, however. The pouch bags 302, 304 may be 2-sided bags or 4-sided bags, for example.

The first flexible container 124 has a neck 310 and the first portion 138 of the coupling 128 is coupled to the neck 310 of the first flexible container 124. The second flexible container 126 also has a neck 312 and the second portion 140 of the coupling 128 is coupled to the neck 312 of the second flexible container 126. The first flexible container 124 and the second flexible container 126 are shown being symmetric about a central longitudinal axis 314.

The first flexible container 124 may include a first material in some implementations and the second flexible container 126 may include a second material. The first material may the same or different from the first material. The first material may be stiffer than the second material and may be resistant to air permeability. The first flexible container 124 may prevent or inhibit the gas used to pressurize the second flexible container 126 from passing through the first flexible container 124 and accessing the reagent 118 within the first flexible container 124. The first flexible container 124 may be metalized to deter the gas from passing into the interior 132 of the first flexible container 124, for example.

The coupling 128 has a pressure fluidic line 316 and a reagent fluidic line 318. The pressure fluidic line 316 is shown extending between the pressure port 144 and the second portion 140 of the coupling 128 and the reagent fluidic line 318 is shown extending between the reagent port 142 and the first portion 138 of the coupling 128. The pressure fluidic line 316 extends through the second portion 140 of the coupling 128 to enable the pressure source 106 of the system 100 of FIG. 1 to change the pressure within the second flexible container 126 and the reagent fluidic line 318 extends through the first portion 138 and the second portion 140 of the coupling 128 to enable the reagent 118 to flow out of the first flexible container 124.

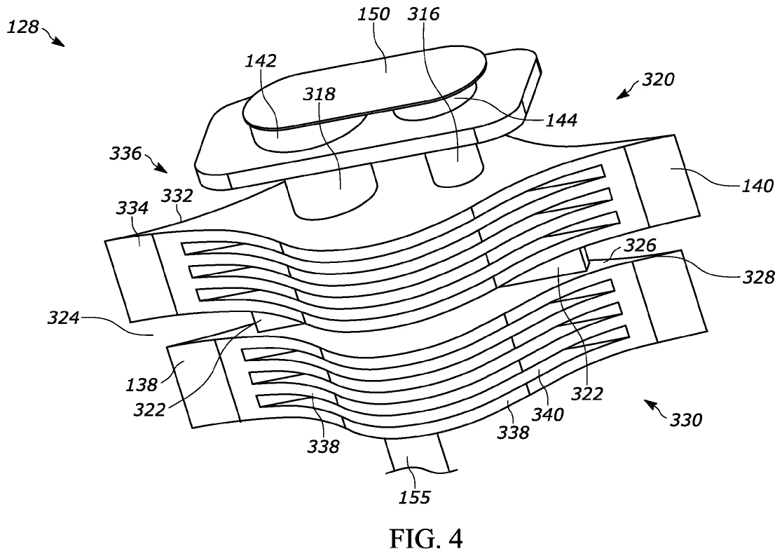

FIG. 4 is an isometric view of the coupling 128 of the reagent cartridge 300 of FIG. 3. The coupling 128 is a fitment 320 and may be referred to as a dual fitment because the fitment 320 includes both the first portion 138 and the second portion 140. The coupling also has spacers 322 that are positioned between the first portion 138 and the second portion 140. The spacers 322 define a gap 324 between the first portion 138 and the second portion 140 and allow both of the couplings between the first flexible container 124 and the first portion 138 and between the second flexible container 126 and the second portion 140 to not affect one another.

The first portion 138 of the coupling 128 has opposing first side walls 326, 328 that form a first canoe shape 330 and the second portion 140 of the coupling 128 has opposing second side walls 332, 334 that form a second canoe shape 336. The first canoe shape 330 is smaller than the second canoe shape 336. The first canoe shape 330 has a smaller width and a smaller depth than the second canoe shape 336 shown. The first flexible container 124 and the second flexible container 126 can each form a coupling with the corresponding canoe shapes 330, 336 as a result of the sizing of the canoe shapes 330, 336, with the first flexible container 124 coupled to the first canoe shape 330 and the second flexible container 126 coupled to the second canoe shape 336. The first canoe shape 330 and the second canoe shape 336 may alternatively be similar or the same sizes. Manufacturing the coupling 128 may be simplified if the canoe shapes 330, 336 are similar or the same. The coupling 128 may be more easily coupled to the first flexible container 124 and the second flexible container 126 if the canoe shapes 330, 336 are similar or the same.

Each of the first portion 138 and the second portion 140 include ribs 338 that are separated by slots 340. The ribs 338 and the slots 340 may facilitate manufacturability of the coupling 128. The coupling 128 may be an injection molded part in some implementations.

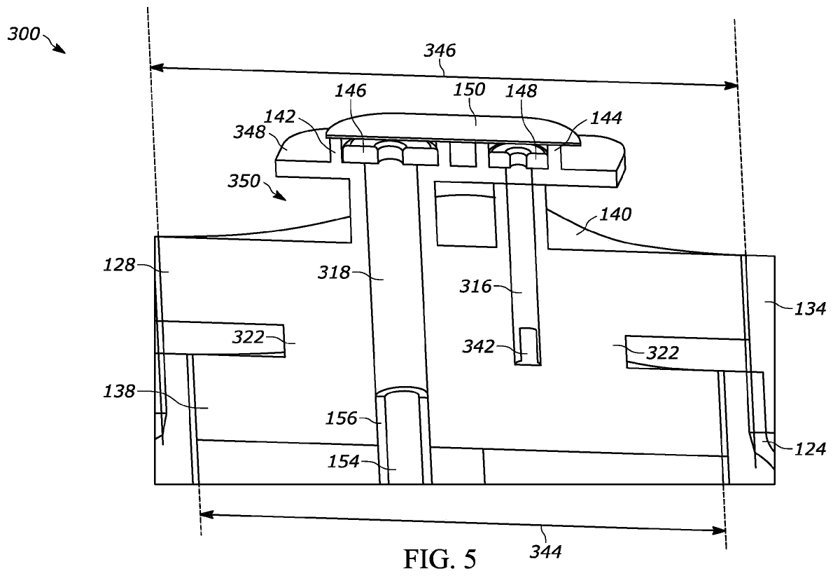

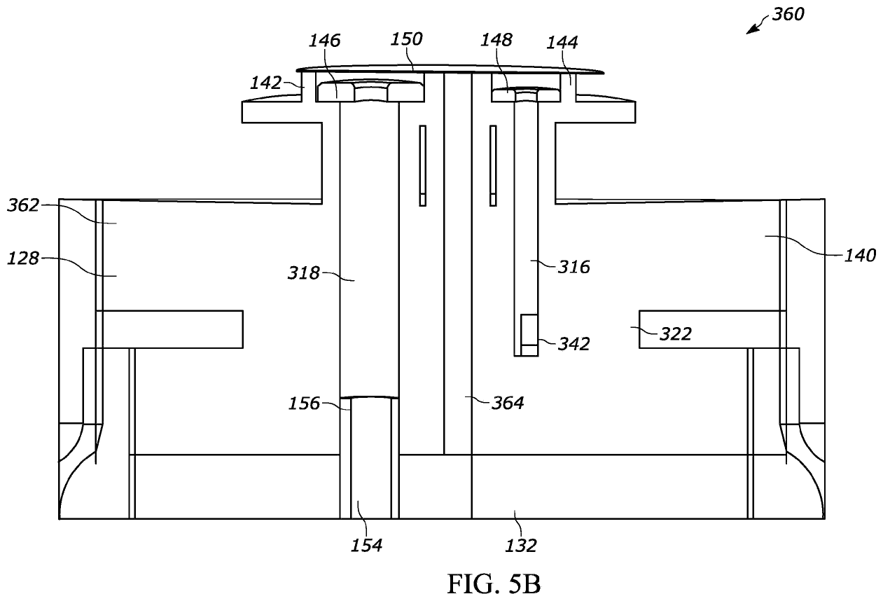

FIG. 5A is a detailed isometric cross-sectional view of the reagent cartridge 300 of FIG. 3. The coupling 128 includes the first portion 138, the second portion 140, the pressure fluidic line 316, and the reagent fluidic line 318. The pressure fluidic line 316 includes an exit port 342 positioned between the first portion 138 and the second portion 140 and defined by the spacer 322. The exit port 342 of the pressure fluidic line 316 is positioned to be fluidly coupled to the second flexible container 126.

The first portion 138 of the coupling 128 has a first width 344 and the second portion 140 of the coupling 128 has a second width 346 that is wider than the first width 344. The coupling 128 also a head 348 in the implementation shown having the pressure port 144 and the reagent port 142 and a neck 350 positioned between the head 348 and the second portion 140 of the coupling 128.

FIG. 5B is a detailed isometric cross-sectional view of a reagent cartridge 360 that can be used to implement the reagent cartridge 102 of FIG. 1. The reagent cartridge 360 is similar to the reagent cartridge 300 of FIG. 3. The reagent cartridge 360 of FIG. 5B, however, includes an alternative coupling 362 including a vent 364. The vent 364 fluidly couples the interior 132 of the first flexible container 124 to atmosphere when the cover 150 is not covering the reagent port 142 and the pressure port 144. The reagent cartridge 360 may be filled with the reagent 118 after the reagent cartridge 360 is manufactured based on the inclusion of the vent 364. The reagent cartridge 360 may be filled with the reagent 118 by flowing the reagent 118 through the reagent port 142 into the interior 132 of the first flexible container 124 as air or gas vents to atmosphere through the vent 364. The cover 150 may be coupled to the coupling 362 covering the reagent port 142 and the pressure port 144 after a threshold amount of the reagent 118 is added to the first flexible container 124.

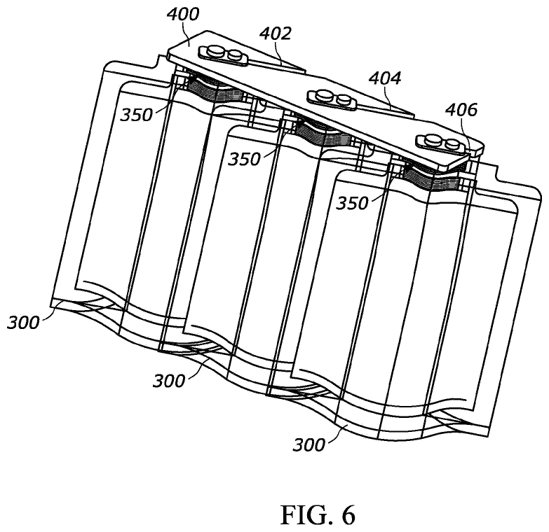

FIG. 6 is an isometric view of a plurality of reagent cartridges 300 of FIG. 3 that are coupled together using a plate 400. The plate 400 defines a plurality of slots 402, 404, 406. The necks 350 of the reagent cartridges 300 are positioned within the corresponding slots 402, 404, 406 to couple the reagent cartridges 300 and the plate 400. The reagent cartridge receptacle 105 of the system 100 may receive the plate 400 to position and hold the reagent cartridges 300 within the system 100. The reagent cartridge receptacle 105 may include rails and/or define opposing grooves to allow the plate 400 to be received.

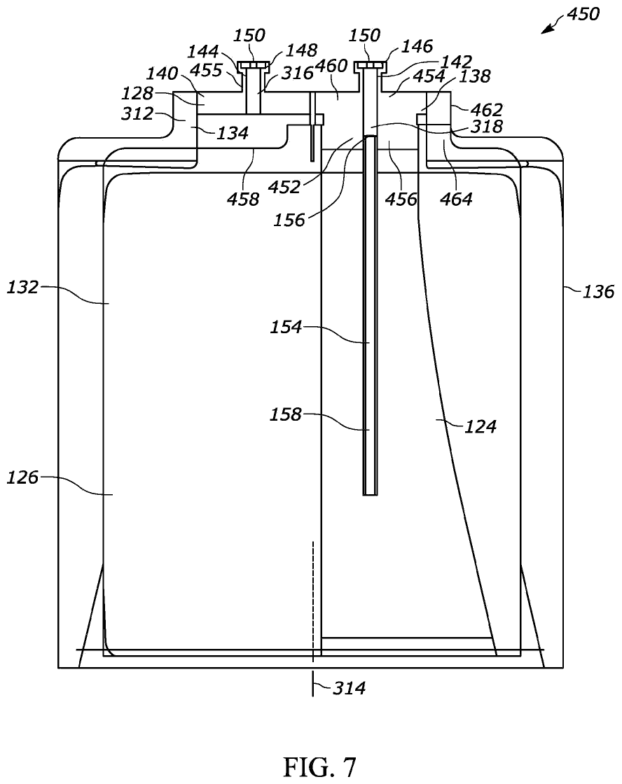

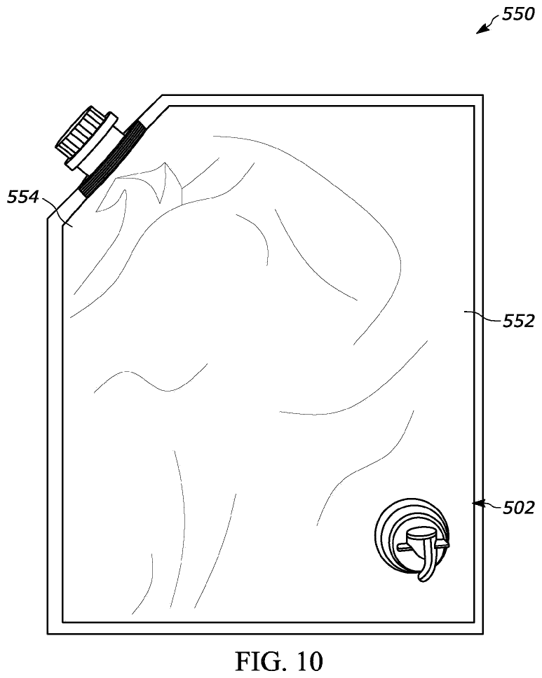

FIG. 7 is a side view of a reagent cartridge 450 that can be used to implement the reagent cartridge 102 of FIG. 1. The reagent cartridge 450 is similar to the reagent cartridge 300 of FIG. 3. The reagent cartridge 450 of FIG. 7, however, includes an alternative coupling 452 having a first portion 454 and a second portion 455. The first portion 454 is shown as a separate component from the second portion 456 and, thus, each of the portions 454, 456 can be positioned in any location on the reagent cartridge 450 including being positioned adjacent to one another as shown in FIG. 7 or spaced from one another (see, FIG. 10, for example). The first portion 454 may be referred to as a reagent fitment and the second portion 456 may be referred to as a pressure fitment. The reagent fluidic line 318 extends through the first portion 454 and is not shown extending through the second portion 456. The pressure fluidic line 316 extends through the second portion 456 and is not shown extending through the first portion 454. The first flexible container 124 includes an end 462 having a neck 464 that is spaced from the longitudinal axis 314 of the reagent cartridge 450.

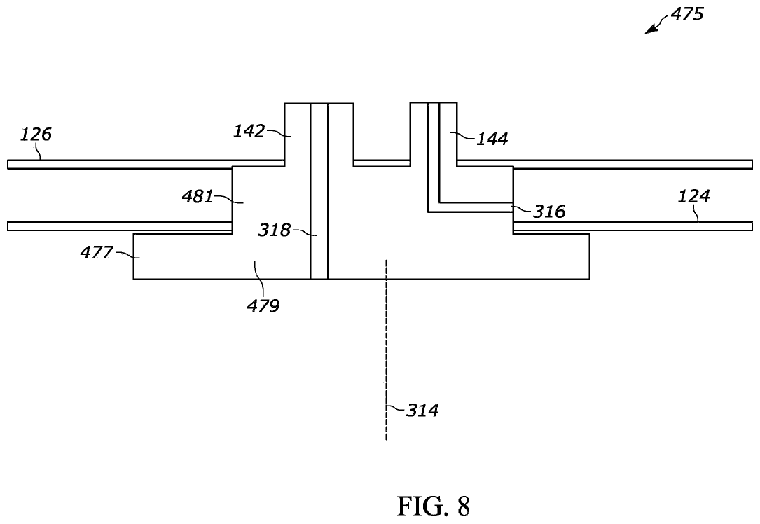

FIG. 8 is a detailed cross-sectional view of a reagent cartridge 475 that can be used to implement the reagent cartridge 102 of FIG. 1. The reagent cartridge 475 is similar to the reagent cartridge 300 of FIG. 3. The reagent cartridge 475 of FIG. 8, however, includes an alternative coupling 477 having a first portion 479 and a second portion 481. The coupling 477 may be referred to as a dual panel fitment. The first portion 479 is coupled to the first flexible container 124 and the second portion 481 is coupled to the second flexible container 126. The coupling 477 may be coupled to a side of the first and/or second flexible container 124, 126 or at the end of the first and/or second flexible containers 124, 126. The coupling 477 includes the reagent fluidic line 318 that extends through the first portion 479 and the second portion 481 and the pressure fluidic line 316 that extends through the first portion 479. The pressure fluidic line 318 includes a dog-leg in the implementation shown and, thus, includes a portion substantially parallel to the longitudinal axis 314 and a portion substantially perpendicular to the longitudinal axis 314. The phrase “substantially parallel” means between about +/−5° of parallel including parallel itself and the phrase “substantially perpendicular” means between about +/−5° of perpendicular including perpendicular itself.

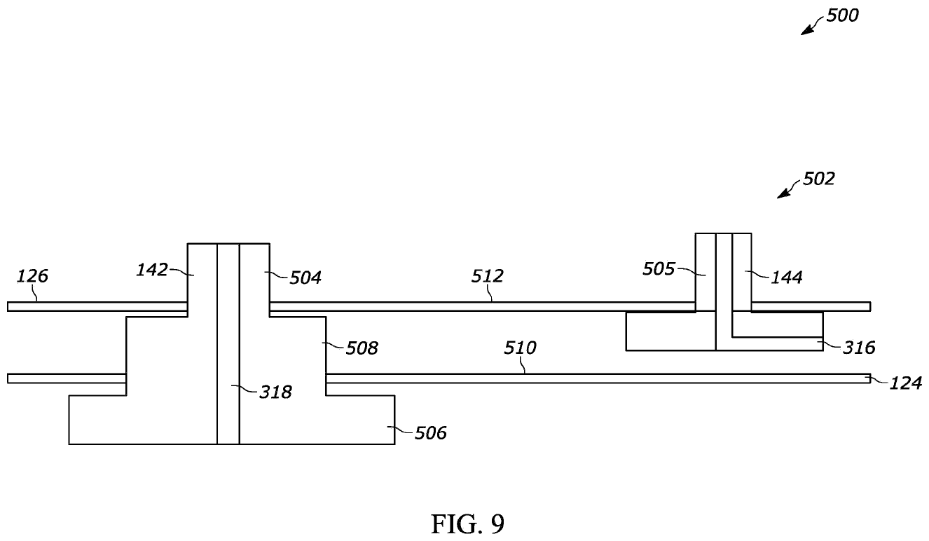

FIG. 9 is a detailed cross-sectional view of a reagent cartridge 500 that can be used to implement the reagent cartridge 102 of FIG. 1. The reagent cartridge 500 is similar to the reagent cartridge 450 of FIG. 7. The reagent cartridge 500 of FIG. 9 includes an alternative coupling 502 including a first portion 504 and a second portion 505. The first portion 504 is spaced from the second portion 506 and defines first and second steps 506, 508. The first step 506 has a surface that is adjacent to or engages an inner surface 510 of the first flexible container 124 and the second step 508 has a surface adjacent to or engages an inner surface 512 of the second flexible container 126.

FIG. 10 is a side view of a reagent cartridge 550 that can be used to implement the reagent cartridge 102 of FIG. 1. The reagent cartridge 550 includes a side panel 552 and an edge 554. The reagent cartridge also includes the coupling 502 including the first portion 504 coupled to the side panel 552 and the second portion 505 coupled to or at the edge 554.

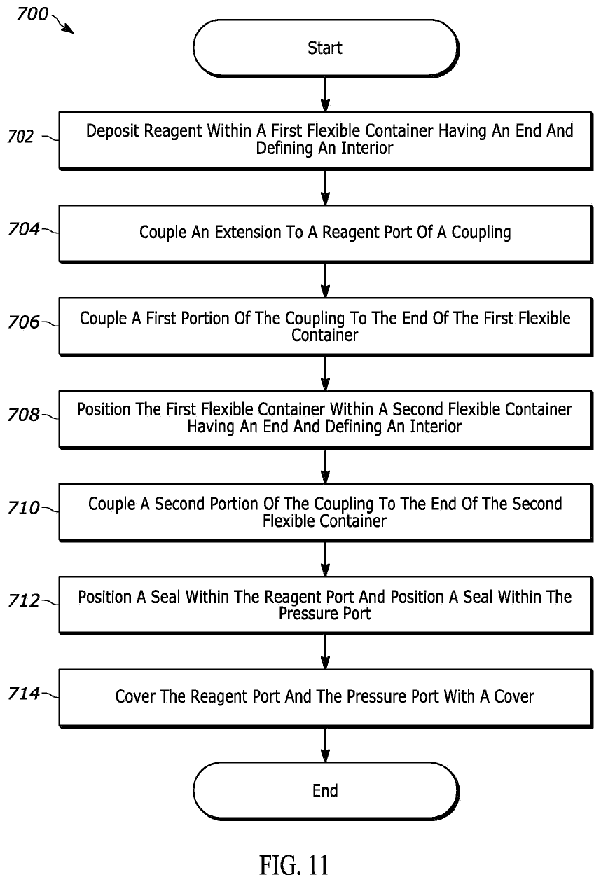

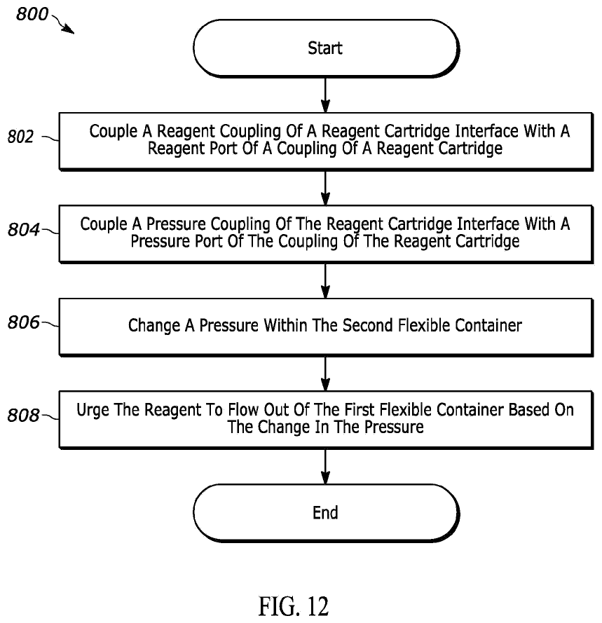

FIG. 11 illustrates a flowchart for a method of assembling the reagent cartridges 102, 202, 300, 360, 450, 475, 500, 550 of FIGS. 1-10 or any of the disclosed implementations and FIG. 12 illustrates a flow chart for a method of flowing reagent out of the reagent cartridges 102, 202, 300, 360, 450, 475, 500, 550 of FIGS. 1-10 or any of the disclosed implementations. The order of execution of the blocks may be changed, and/or some of the blocks described may be changed, eliminated, combined, and/or subdivided into multiple blocks.

The process 700 of FIG. 11 begins with reagent 118 being deposited within the first flexible container 124 having an end 130 and defining an interior 132 (Block 702). The reagent 118 may alternatively be added to the first flexible container 124 after the reagent cartridge 102, 202, 300, 360, 450, 475, 500, 550 is manufactured. The coupling 128 may include the vent 364 in such implementations to allow the first flexible container 124 to vent as the first flexible container 124 is filled with the reagent 118. An extension 154 is coupled to the reagent port 142 of the coupling 128 (Block 704). The extension 154 is a tube 155 in some implementations. The extension 154 may alternatively be omitted.

The first portion 138 of the coupling 128 is coupled to the end 130 of the first flexible container 124 (Block 706). The coupling 128 has the reagent port 142 fluidly coupled to the interior 132 of the first flexible container 124 and a pressure port 144. The extension 154 extends into the interior 132 of the first flexible container 124 after the first portion 138 of the coupling 128 is coupled to the end 130 of the first flexible container 124.

The first flexible container 124 is positioned within the second flexible container 126 having the end 134 and defining the interior 136 (Block 708). The second portion 140 of the coupling 128 is coupled to the end 134 of the second flexible container 126 (Block 710). The pressure port 144 is fluidly coupled to the interior 136 of the second flexible container 126. A seal 146 is positioned within the reagent port 142 and a seal 148 is positioned within the pressure port 144 (Block 712). The reagent port 142 and the pressure port 144 are covered with the cover 150 (Block 714).

The process of FIG. 12 begins with the reagent coupling 120 of the reagent cartridge interface 108 being coupled with the reagent port 142 of the coupling 128 of the reagent cartridge 102, 202, 300, 360, 450, 475, 500, 550 (Block 802). The reagent cartridge 102, 202, 300, 360, 450, 475, 500, 550 has a first flexible container 124, the second flexible container 126, and the coupling 128. The first flexible container 124 includes the end 130 and defines the interior 132 containing reagent 118 and the second flexible container 126 has the end 134 and defines the interior 136. The first flexible container 124 is positioned within the interior 136 of the second flexible container 126. The coupling 128 is coupled to the end 130 of the first flexible container 124 and the end 134 of the second flexible container 126.

The pressure coupling 122 is coupled with the pressure port 144 of the coupling 128 of the reagent cartridge 102, 202, 300, 360, 450, 475, 500, 550 (Block 804). A pressure within the second flexible container 126 is changed (Block 806). The change in pressure may be an increase in pressure or a decrease in pressure. The reagent 118 is urged to flow out of the first flexible container 124 based on the change in the pressure (Block 808).

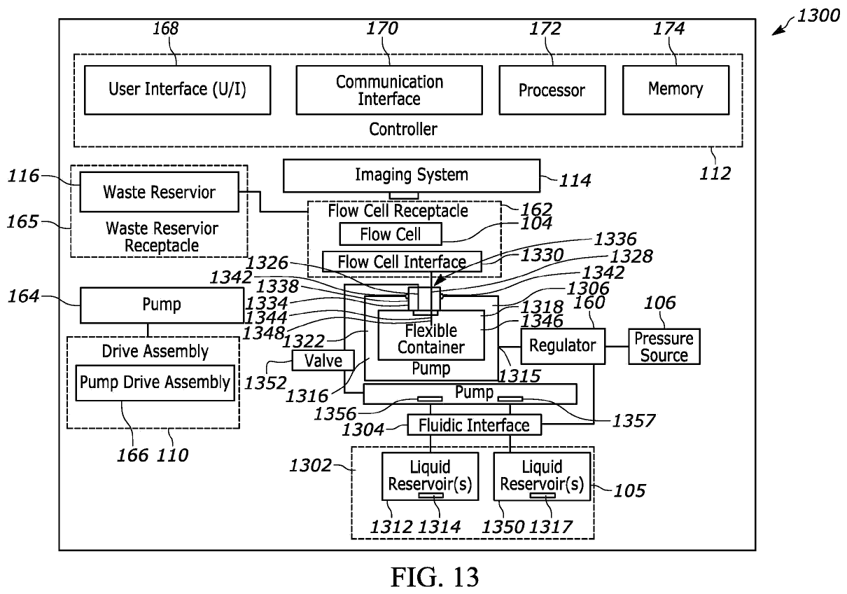

FIG. 13 illustrates a schematic diagram of an implementation of another system 1300 in accordance with the teachings of this disclosure. The system 1300 is similar to the system 100. The system 1300 of FIG. 13 includes a reservoir receptacle 1302, a fluidic interface 1304, a pump 1306, the pressure source 106, and the flow cell receptacle 162 in the implementation shown. The reservoir receptacle 1302 receives a reservoir 1312 and the fluidic interface 1304 is fluidly coupled to the reservoir 1312. The reservoir 1312 may be referred to as a reagent reservoir or a reagent cartridge. The reservoir 1312 is shown including fluid 1314. The fluid 1314 may be reagent or another liquid.

The pump 1306 is fluidly coupled to the fluidic interface 1304 and includes a housing 1316 having a pressure port 1315 and a flexible container 1318 disposed in the housing 1316 in the implementation shown. The flexible container 1318 may include and/or be formed by any number of panels that form a small pouch bag and/or a quad bag or other types of bags. The flexible container 1318 may be formed by two panels, three panels, four panels, five panels, for example. The pump 1306 is shown including one flexible container 1318 but may alternatively include more than one flexible container 1318.

The flexible container 1318 includes an inlet 1326 and an outlet 1328 in the implementation shown. The inlet 1326 may be referred to or associated with a coupling and the outlet 1328 may be referred to or associated with a coupling. The inlet 1326 and the outlet 1328 are each externally accessible outside of the housing 1316 to allow fluid 1314 to flow into the inlet 1326 of the flexible container 1318 and/or out of the outlet 1328 of the flexible container 1318. The inlet 1326 of the flexible container 1318 is fluidly coupled to the fluidic interface 1304. The fluid 1314 can accordingly flow from the reservoir 1312 to the inlet 1326 of the flexible container 1318.

The pressure source 106 is coupled with the pressure port 1315 and is in fluid communication with the housing 1316 in the implementation shown. The flow cell receptacle 162 receives a flow cell 104 and has a flow cell interface 1330 fluidly coupled to the outlet 1328 of the flexible container 1318.

The system 1300 further includes a flow cell receptacle 162 to receive a flow cell 104. The flow cell receptacle 162 and/or the system 100 may further include a flow cell interface 1330 fluidly coupled to the outlet 1328 of the flexible container 1318.

The fluid 1314 flows from the reservoir 1312 to the inlet 1326 of the flexible container 1318 in operation and the pressure source 106 pressurizes the housing 1316 and urges the fluid 1314 out of the outlet 1328 of the flexible container 1318 toward the flow cell receptacle 162. The pressure source 106 may positively pressurize the housing 1316 to urge the fluid out of the outlet 1328 of the flexible container 1318. The pressure source 106 may positively pressurize the housing 1316 to about 5 pounds per square inch gauge (psig). The pressure source 106 may pressurize the housing 1316 to less than 5 psig or greater than 5 psig, however. For example, the pressure source 106 may be configured to positively pressurize the housing 1316 to approximately more than 5 psig, 10 psig, 15 psig, etc. Alternatively, the pressure source 106 may reduce the pressure in the housing 1316. For example, the pressure source 106 may be configured to pull a vacuum in the housing 1316.

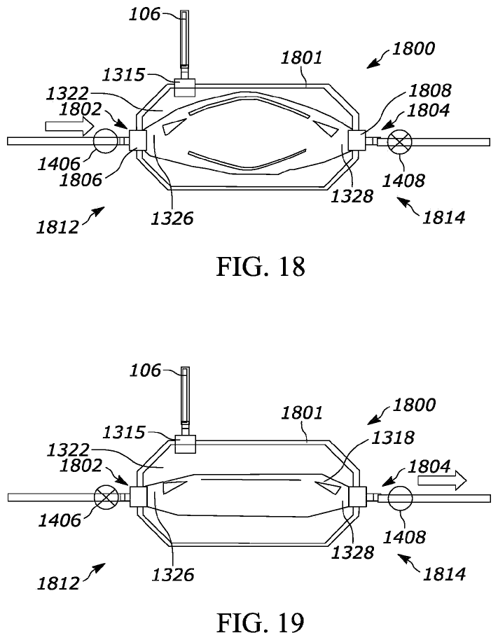

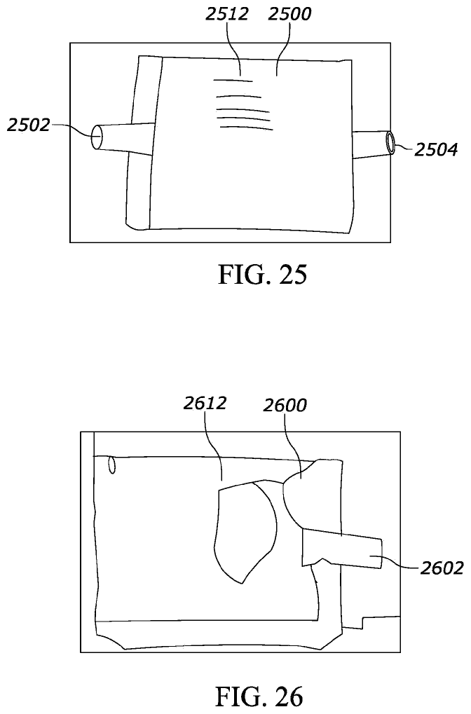

The flexible container 1318 has a coupling 1334 that includes the inlet 1326 and the outlet 1328 in the implementation shown. The inlet 1326 and the outlet 1328 may be separate as shown in FIG. 18, however. The housing 1316 additionally includes an aperture 1336 through which the coupling 1334 extends to enable the inlet 1326 and the outlet 1328 to be externally accessible outside of the housing 1316. The coupling 1334 may be implemented by a fitment 1338, as an example. The coupling 1334 may be implemented in different ways to secure the aperture 1336 to the housing 1316, however. For example, the coupling including the inlet 1328 may be a portion of the flexible container 1318 (see for example, FIG. 25)) and the coupling including the outlet 1330 may be another portion of the flexible container (see for example, FIG. 25) and/or the inlet 1326 and the outlet 1328 may alternatively be implemented by a three-way valve in some implementations. The fluid 1314 may flow from the reservoir 1312 into the three-way valve and the three-way valve may be positioned and/or actuated to route the fluid 1314 to the inlet 1326 and into the flexible container 1318. The three-way valve may be positioned and/or actuated to route the fluid 1314 out of the outlet 1328 and to dispense the fluid 1314 from the flexible container 1318.

The pump 1306 includes a seal 1342 disposed between the coupling 1334 and the housing 1316 in the implementation shown. The seal 1342 may alternatively be omitted. The seal 1342 inhibits pressurized gas from exiting the housing 1316. The housing 1316 has a pressure chamber 1322 in which the flexible container 1318 is disposed and the seal 1342 hermetically seals the pressure chamber 1322. For example, the seal 1342 provides a hermetic seal between an outer surface of the coupling 1334 and a surface of the housing 1316 that defines the aperture 1336. The pressure port 1315 is in fluid communication with the chamber 1322 and is configured to pressurize the chamber 1322, as disclosed above.

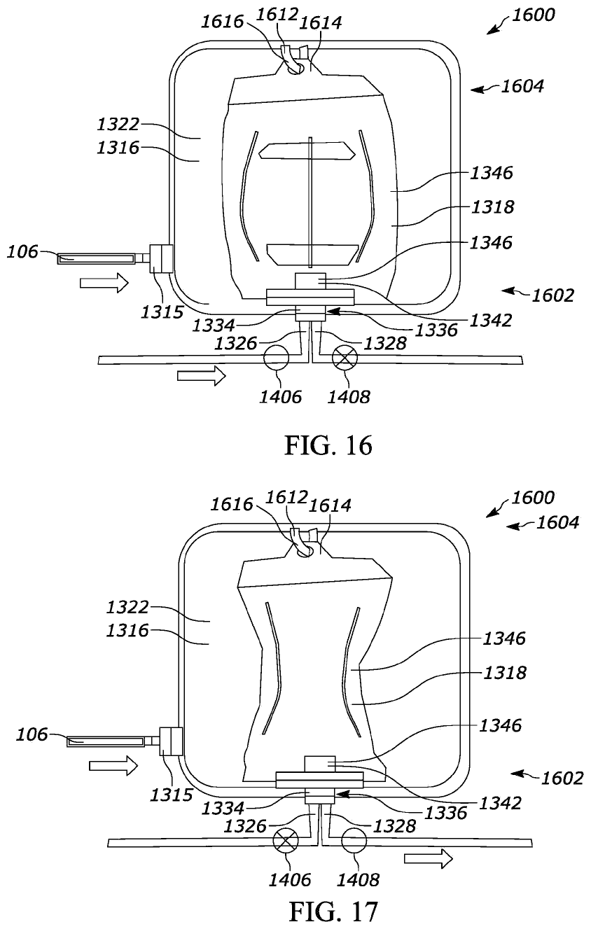

The coupling 1334 in the implementation shown includes an extension 1344 and the flexible container 1318 has an interior 1346 that the extension 1344 extends into. The extension 1344 may be implemented by a tube 1348. The extension 1344 may be implemented in different ways or may be omitted (See, FIGS. 16 and 17), however.

The reservoir receptacle 1302 of the system 1300 of FIG. 13 is shown receiving a second reservoir 1350. The second reservoir 1350 contains fluid 1317. The fluid 1314, 1317 may be the same or different. The fluidic interface 1304 is fluidly coupled to the second reservoir 1350 and the first reservoir 1312, in the implementation shown. The second reservoir 1350 may be omitted or any number of additional reservoirs may be included (e.g., 3, 4, 9, 15), however.

The system 1300 is shown including a valve 1352 that selectively controls fluid flow from the reservoir 1312 to the inlet 1326 of the flexible container 1318 and from the second reservoir 1350 to the inlet 1326 of the flexible container 1318. The valve 1352 is shown being implemented by a three-way valve. The valve 1352 may be any type of valve used for controlling fluid flow, however. Additionally or alternatively, the system 1300 may include a Y-junction that may pass fluid from reservoir 1312 and the reservoir 1350 through the inlet 1326 during different times or a similar or the same time period.

The system 1300 includes a pair of second pumps 1356, 1357 in the implementation shown. The pump 1356 corresponds to the reservoir 1312 and is used to pump the fluid 1314 from the reservoir 1312 toward and into the flexible container 1318. The pump 1357 corresponds to the second reservoir 1350 and is used to pump the fluid 1317 from the second reservoir 1350 toward and into the flexible container 1318. The pumps 1356, 1357 are positioned upstream of the pump 1306. The pumps 1356, 1357 may be configured to dispense the fluid 1314, 1317 into the flexible container 1318 to enable jet mixing. For example, the second fluid 1317 may be jet-mixed with the first fluid 1314 within the flexible container 1318. In various examples, jet-mixing uses the kinetic energy of a pumped stream to blend the liquid contents in a container. As a result, the fluid 1314, 1317 may be passed into the flexible container 1318 at a high speed. In other examples, the system 1300 may include alternative apparatus to mix the fluid 1314 and the fluid 1317. For example, the system 1300 may include a magnetic stirrer and/or magnetic stir plate and a magnetic stirrer may be disposed in the flexible container 1318 of the pump 1306.

The system 1300 may alternatively include a single pump that is used to pump the fluid 1314 from the reservoirs 1312, 1350 toward the flexible container 1318. One of the pumps 1356, 1357 may be omitted in such an example, and the remaining pump 1356 or 1357 may be used to pump fluid 1314, 1317 from either or both of the reservoirs 1312, 1350. The system 1300 is shown including the pump 164 to flow fluid 1314 from the reservoir 1312, 1350 to the flexible container 1318. The pump 164 may be referred to as a second pump. The pump 164 is shown positioned upstream of the pump 1306. The pump 164 may alternatively be positioned downstream from the pump 1306.

In some examples, the pump 1306 is replaceable and is replaced after use or on a consistent basis. In other examples, the pump 1306 may be reusable. In such examples, sometimes the flexible container 1318 benefits from being washed or cleaned. For example, in some examples, the fluid 1314 or the fluid 1317 may partially crystallize in the flexible container 1318. In such examples, a washing fluid may be passed through the flexible container 1318 to flush the flexible container 1318.

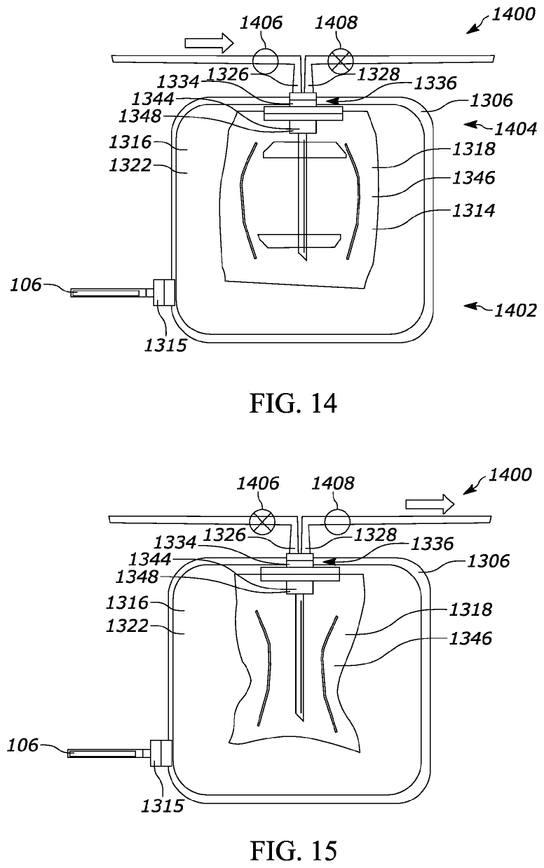

FIG. 14 is a side view of an implementation of a pump 1400 that can be used to implement the pump 1306 of FIG. 13, with the pressure chamber 1322 of the housing 1316 being below a threshold pressure. The flexible container 1318 is, thus, expanded and not as compressed based on the pressure chamber 1322 being below a threshold pressure.

The pump 1400 of FIG. 14 includes the housing 1316 and the flexible container 1318. The pump 1400 may be used to meter fluid 1314 to the flow cell 104 of the system 1300, for example. The flexible container 1318 is disposed in the housing 1316 and includes the inlet 1326 and the outlet 1328. The pump 1400 includes the coupling 1334 and the extension 1344 that extends into the flexible container 1318 from the coupling 1334. The coupling 1334 may be part of the housing 1316 and/or part of the flexible container 1318. The housing 1316 includes a lower portion 1402 and an upper portion 1404 and the aperture 1336 is defined in the upper portion 1404. The coupling 1334 extends through the aperture 1336. The lower portion 1402, includes the pressure port 1315 in the implementation shown. In alternative examples, the pressure port 1315 can be disposed elsewhere on the housing 1316, such as the upper portion 1404.

The pump 1306 of FIG. 14 and/or a related system (the system 1300 of FIG. 13) may also include a first valve 1406 and a second valve 1408. The first valve 1406 may be referred to as an inlet valve and the second valve 1408 may be referred to as an outlet valve. The first valve 1406 controls fluid flow into the inlet 1326 of the flexible container 1318 and the second valve 1408 controls fluid flow out of the flexible container 1318. The valves 1406, 1408 may be implemented by any suitable valve. Reagent is pumped into the flexible container 1318 through the inlet 1326 when the first valve 1406 is open and the second valve 1408 is closed in operation to reach a fixed metered volume within the flexible container 1318.

FIG. 15 is a side view of the pump 1400 of FIG. 14, with the pressure chamber 1322 of the housing 1316 being above a threshold pressure. The flexible container 1318 is, thus, more compressed based on the pressure chamber 1322 being above the threshold pressure. The fixed metered volume of the regent contained within the flexible container 1318 is dispensed out through the outlet 1328 when the second valve 1408 is open, and the first valve 1406 is closed.

FIG. 16 is a side view of an implementation of a pump 1600 that can be used to implement the pump 1306 of FIG. 13, with the pressure chamber 1322 of the housing 1316 being below a threshold pressure. The pump 1600 is similar to the pump 1400 of FIG. 14. The pump 1600 of FIG. 16, however, includes the aperture 1336 defined by the lower portion 1602 of the housing 1316. The lower portion 1602, thus, includes both the pressure port 1315 and the aperture 1336 in the implementation shown. In alternative examples, the pressure port 1315 can be disposed elsewhere on the housing 1316, such as the upper portion 1604. The coupling 1334 extends through the aperture 1336 defined by the lower portion 1602 opposite the upper portion 1604 of the housing 1316. The fluid 1314 may flow out of the outlet 1328 based on gravity, for example, and the extension 1344 is omitted from the pump 1600.

The pump 1600 of FIG. 16 also includes a coupling 1612 that is used to couple an end 1614 of the flexible container 1318 to the housing 1316. The coupling 1612 is shown coupled between the upper portion 1604 of the housing 1316 and the end 1614 of the flexible container 1318. The coupling 1612 may be a strap 1616. The strap 1616 may be a zip tie or hook, for example.

FIG. 17 is a side view of the pump 1600 of FIG. 16, with the pressure chamber 1322 of the housing 1316 being above a threshold pressure.

FIG. 18 is a side view of an implementation of a pump 1800 that can be used to implement the pump 1306 of FIG. 13. The pump 1800 is similar to the pump 1400 of FIG. 14 and the pump 1600 of FIG. 16. The pump 1800 of FIG. 18, however, includes a housing 1801 having a first aperture 1802 and a second aperture 1804. The flexible container 1318 includes a first coupling 1806 having the inlet 1326 and a second coupling 1808 having the outlet 1328. The housing 1801 defines a first end 1812 and a second end 1814. The first coupling 1806 is coupled at the first end 1812 of the housing 1801 and the second coupling 1808 is coupled at the second end 1814 of the housing 1801. The pressure chamber 1322 of the housing 1316 is shown below a threshold pressure in the implementation shown.

FIG. 19 is a side view of the pump 1800 of FIG. 18, with the pressure chamber 1322 of the housing 1801 being above a threshold pressure.

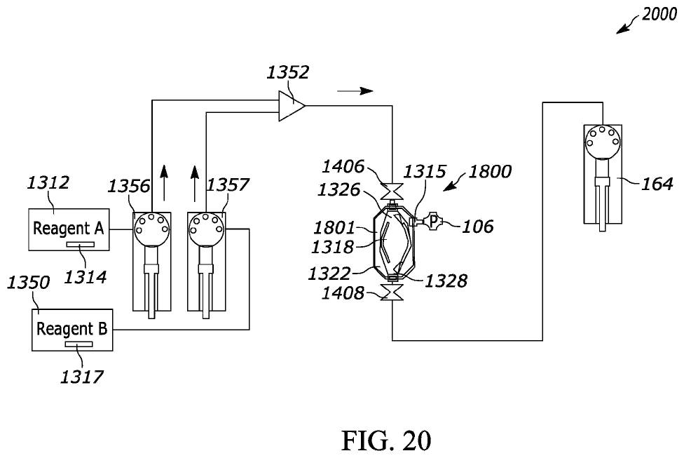

FIG. 20 illustrates the pump 1800 of FIG. 18 coupled with the pumps 1356, 1357, 164, and liquid reservoirs 1312, 1350 of FIG. 13. The pump 1800 is used to meter fluid 1314, 1317 during different processes. The pump 1356, 1357, 164 may be implemented by a syringe pump, a peristaltic pump, a diaphragm pump, etc. More or fewer components may be included than shown in FIG. 20. For example, the system 2000 could include one liquid reservoir 1312 or more than two liquid reservoirs and a corresponding number of second pumps.

The pump 1800 receives the first fluid 1314 of the first reservoir 1312 from the pump 1356 in operation and receives the second fluid 1317 of the second reservoir 1350 from the second pump 1357. In some examples, the pump 1356 and the second pump 1357 are operated simultaneously, but the pump 1356 and the second pump 1357 may operate separately. As shown, the first fluid 1314 and the second fluid 1317 may pass through the valve 1352 before reaching the pump 1800.

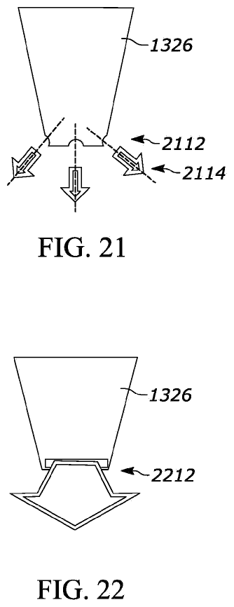

FIG. 21 is a schematic view of an inlet 2100 that can be used to implement the inlet 1326 of any of the pumps 1306, 1400, 1600, 1800 disclosed herein. The inlet 2100 includes a plurality of openings 2112. Each of the openings 2112 has a central axis 2114 that is positioned approximately 45 degrees)(° relative to one another. For example, the axes 2114 may be positioned between about 30° and about 60° relative to one another. Each of the openings 2112 may be implemented by a converging nozzle.

FIG. 22 is a schematic view of another inlet 2200 that can be used to implement the inlet 1326 of any of the pumps 1306, 1400, 1600, 1800 disclosed. The inlet 2200 includes a converging nozzle 2212. FIGS. 21 and 22 are example nozzle structures that can be used to mix fluids in an enclosed container, but could be implemented by any other nozzle-type structure.

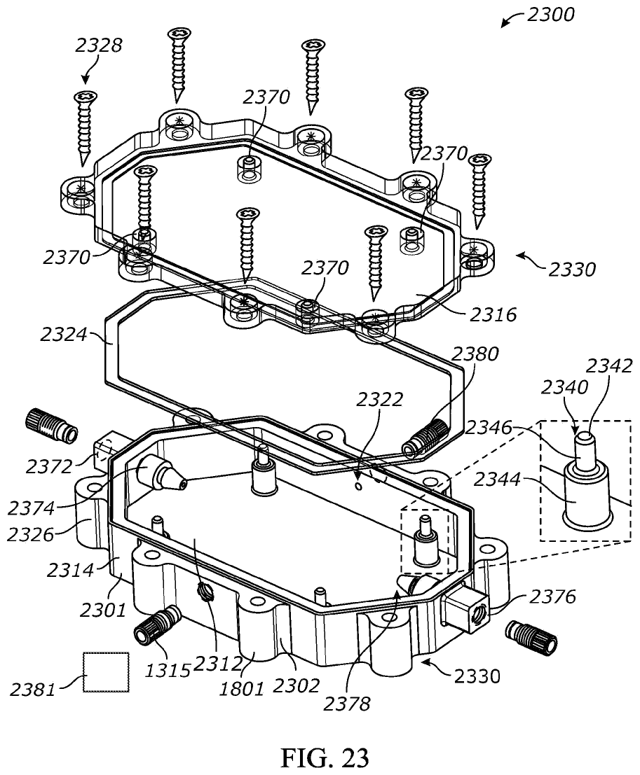

FIG. 23 illustrates an expanded view of a pump 2300 that can be used to implement the pump 1800 of FIG. 18. The pump 2300 includes a housing 2301 including a body 2302 having a base 2312, a sidewall 2314, and a lid 2316. The base 2312 and the sidewall 2314 define a chamber 2322 and the lid 2316 encloses the chamber 2322 when disposed on the sidewall 2314. The base 2312 and the sidewall 2314 are shown integrally formed. The sidewall 2314 may alternatively be a separate component that is secured to the base 2312 using fasteners and/or adhesive(s).

The housing 2301 also includes a gasket 2324 and the sidewall 2314 has an end 2326. The gasket 2324 is disposed between the sidewall 2314 and the lid 2316 at the end 2326 of the sidewall 2314 when the lid 2316 is attached to the body 2302. In some examples, the lid 2316 may be hermetically sealed to the sidewall 2314 without the use of the gasket 2324. The lid 2316 may be removably secured to the sidewall 2314. The housing 2301 also is shown including a plurality of fasteners 2328 to removably secure the lid 2316 to the sidewall 2314. The fasteners 2328 are disposed about a perimeter 2330 of the lid 2316 and the sidewall 2314 but may be implemented in other positions.

The fasteners 2328 are shown being implemented by screws. The fasteners 2328 may be implemented by bolts, latches, hinges and/or other similar selective fasteners. In some examples, the lid 2316 can be hermetically sealed with the sidewall 2314 with as few as one or two fasteners 2328, but in other examples, there may be two or more fasteners 2328. Additionally, in some examples, the lid 2316 may be hingedly coupled to the sidewall 2314 and fasteners 2328 may be disposed on one side of the housing 2301, opposite the hinge. The fasteners 2328 may be screws and/or latches in such examples. The lid 2316 may additionally or alternatively be magnetically secured to the sidewall 2314. Alternatively, the lid may be integral with the sidewall 2314 or permanently secured to the sidewall 2314 (e.g., via adhesive, welding, etc.).

The base 2312 also includes posts 2340 having ends 2342 that extend from the base 2312 and are disposed in the chamber 2322. Each of the posts 2340 includes a cylindrical seat 2344 extending from the base 2312 and having a first diameter and a pole 2346 extending from the cylindrical seat 2344 and having a second diameter. The first diameter is greater than the second diameter. The lid 2316 may include corresponding apertures 2370 that receive the ends 2364 of the posts 2362. The interaction between the posts 2362 and the apertures 2370s can secure corners of the flexible container 1318 within the housing 2301 and/or deter the flexible container 1318 from moving when being filled with and/or dispensing the fluid 1314, 1317. The apertures 2370 may alternatively be omitted, however.

In some examples, the housing 2301 includes a first coupling 2372 including a first nozzle 2374 and a second coupling 2376 including a second nozzle 2378. In the example of FIG. 23, the first coupling 2372 is positioned opposite the second coupling 2376.

Additionally, the pump 2300 includes a pressure sensor port 2380. In various examples, the pressure sensor port 2380 permits a pressure sensor 2381 to measure a pressure within the chamber 2322. The system 1300 of FIG. 13 may include the pressure sensor 2381 in some implementations. The system 1300 may access pressure values from the pressure sensor 2381 and may use the pressure values to monitor and/or control the pressure of the housing 2301, for example. In some examples, the pressure sensor 2381 includes a gauge for visual inspection. Additionally or alternatively, the pressure sensor 2381 may be electrically connected to a controller. In such examples, a controller may be configured to control the operation of the pump 2300 in the context of a larger system (e.g., system 1300). Additionally, in various examples, the pressor port 1380 can be incorporated into the pressure pump 1306, 1400, 1600, 1800. The pressure sensor 2381 may alternatively be omitted.

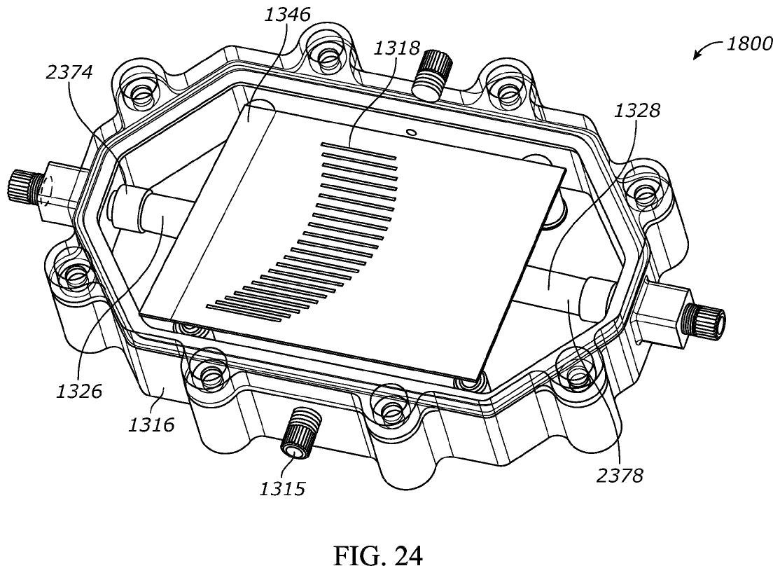

FIG. 24 is a perspective view of the pump 2300 of FIG. 23 including a flexible container 1318. The first nozzle 2374 is received in the inlet 1326 of the flexible container 1318. The nozzle 2374 and the inlet 1326 may form a hermetic seal and/or an interference fit. For example, a hermetic seal and/or an interference fit may be formed between the first nozzle 2374 and the inlet 1326. A hermetic seal may be formed in other ways, such as, using a clamp, however. The second nozzle 2378 and the outlet 1328 may also form a hermetic seal and/or an interference fit. A portion of the flexible container 1318 of FIG. 24 including the inlet 1326 may be referred to as a coupling and a portion of the flexible container 1318 of FIG. 24 including the outlet 1328 may be referred to as a coupling.

In other examples, the nozzle 2374 and the inlet 1326 are formed with different mechanical connection structures. For example, the nozzle 2374 and the inlet 1326 may be any other male-female coupling that can form a hermetic seal.

FIG. 25 illustrates a flexible container 2500 that can be used to implement the flexible container 1318 of FIGS. 18, 19, and/or 23. The flexible container 2500 includes a first opening 2502 and a second opening 2504 disposed opposite the first opening 2502. Additionally, the flexible container 2500 includes an interior 2512 disposed between the first opening 2502 and the second opening 2504. The flexible container 2500 is configured to receive and store a fluid or a mixture of fluids within the interior 2512.

FIG. 26 illustrates a flexible container 2600 that can be used to implement the flexible container 1318 of FIGS. 14-17. The flexible container 2600 includes a first opening 2602. Additionally, the flexible container 2600 includes an interior 2612 disposed between the first opening 2602 and the second opening 2604. The flexible container 2600 is configured to receive and store a fluid or a mixture of fluids within the interior 2612.

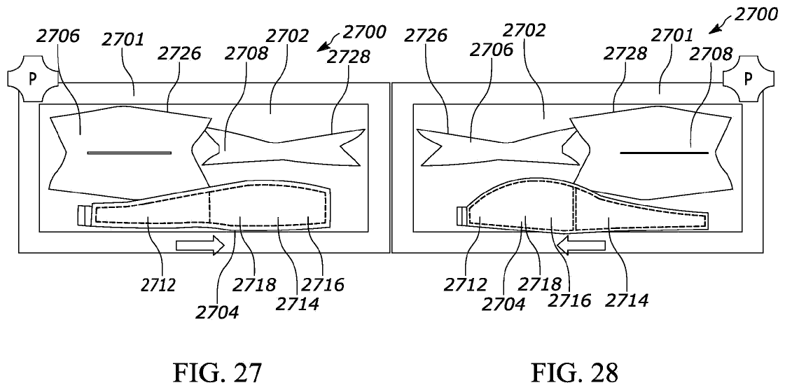

FIG. 27 is a side view of an implementation of a pump 2700 that can be used to implement the pump 1306 of FIG. 13. The pump 2700 is the similar to the pump 1800 of FIG. 18. The pump 2700 may be referred to as a mixing pump and may be used to perform various mixing operations. The pump 2700 of FIG. 27 includes a housing 2701 defining a chamber 2702, a flexible container 2704, a first actuator 2706, and a second actuator 2708, where each of the flexible container 2704, the first actuator 2706, and the second actuator 2708 are positioned within the chamber 2702 of the housing 2701. The first actuator 2706 may be implemented by a first flexible container 2726 and the second actuator 2708 may be implemented by a second flexible container 2728. The actuators 2706 and/or 2708 are inflatable/actuatable to urge fluid out of the flexible container 2704 and/or to mix fluid within the flexible container 2704 in operation.

The flexible container 2704 includes a first portion 2712 and a second portion 2714. The first portion 2712 and the second portion 2714 are in fluid communication. A first fluid 2716 and a second fluid 2718 are shown disposed within the flexible container 2704. The flexible container 2704 may have more or fewer fluids, however.

The first actuator 2706 is actuated in operation to exert pressure on the first portion 2712 of the flexible container 2704 and the second actuator 2708 is actuated to exert pressure on the second portion 2714 of the flexible container 2704. As shown in FIG. 27, the first actuator 2706 is actuated and the second actuator 2708 is not actuated.

When the first actuator 2706 is actuated, at least a portion of the first fluid 2716 and at least a portion of the second fluid 2718 is urged from the first portion 2712 of the flexible container 2704 to the second portion 2714 of the flexible container 2704.

FIG. 28 is a side view of the pump 2700 of FIG. 27, showing the second actuator 2708 actuated and urging at least a portion of the first fluid 2716 and at least a portion of the second fluid 2718 from the second portion 2714 of the flexible container 2704 to the first portion 2712 of the flexible container 2704. During operation, the second actuator 2708 may not actuated when the first actuator 2706 is actuated, and the first actuator 2706 may not actuated be when the second actuator 2708 is actuated.

The first actuator 2706 may be actuated by inflating the first flexible container 2726 and the second actuator 2708 may be actuated by inflating the second flexible container 2728. The first portion 2712 of the flexible container 2704 is compressed when the first flexible container 2726 is inflated and the second portion 2714 of the flexible container 2704 is compressed when the second flexible container 2728 is inflated.

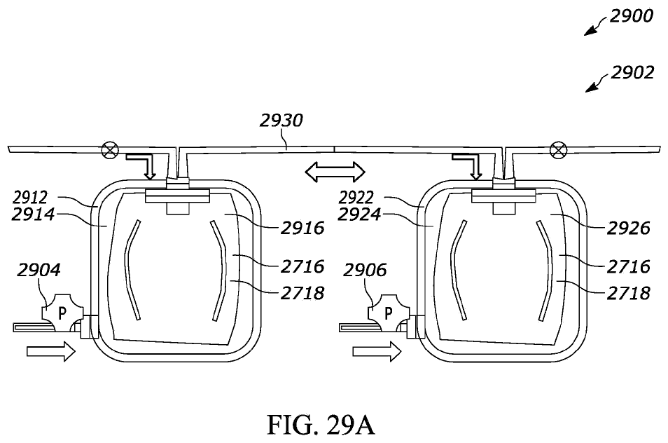

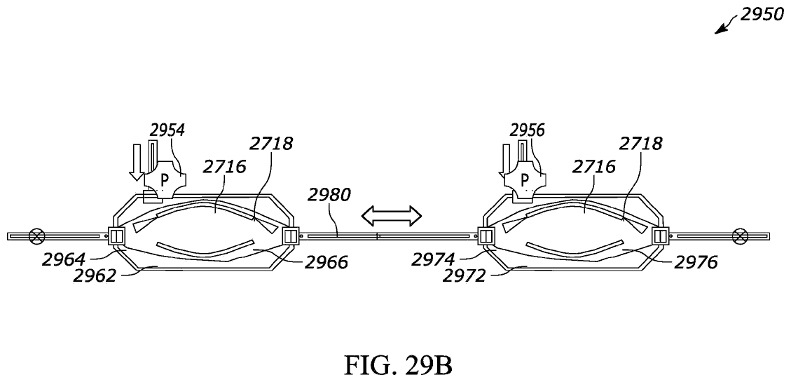

FIG. 29A illustrates a side view of a pump 2900 that can be used to implement the pump 1306 of FIG. 13. The pump 2900 may be referred to as a mixing pump and may be used to perform various mixing operations. The pump 2900 includes a pair of housings 2912, 2922 defining corresponding chambers 2914, 2924, flexible containers 2916, 2926 disposed in the corresponding chambers 2914, 2924, a first pressure source 2904 (e.g., a first actuator), and a second pressure source 2906 (e.g., a second actuator).

The flexible container 2916 is disposed in the first chamber 2914 and the first pressure source 2904 is fluidly coupled with the first chamber 2914. The flexible container 2926 is disposed in the second chamber 2924 and the second pressure source 2906 is fluidly coupled with the second chamber 2924. The pump 2900 also includes a conduit 2930 fluidly coupling the flexible container 2916 and the flexible container 2926.

The first pressure source 2904 positively pressurizes the first housing 2912 and the second pressure source 2906 positively pressurizes the second housing 2922. The flexible container 2916 is compressed when the first housing 2912 is pressurized, and the flexible container 2926 is compressed when the second housing 2922 is pressurized. During operation, alternating the actuation of the first pressure source 2904 and the second pressure source 2906 causes fluid to pass back and forth through the conduit 2930 from flexible container 2916 and the second container 2926 to mix the first fluid 2716 and the second fluid 2718.

FIG. 29B illustrates a side view of a pump 2950 that can be used to implement the pump 1306 of FIG. 13 and is similar to the pump 2900 of FIG. 29A. The pump 2950 may be referred to as a mixing pump and may be used to perform various mixing operations. The pump 2950 includes a pair of housings 2962, 2972 defining corresponding chambers 2964, 2974, flexible containers 2966, 2976 disposed in the corresponding chambers 2964, 2974, a first pressure source 2954, and a second pressure source 2956. The first pressure source 2954 may be referred to as a first actuator and the second pressure source 2956 may be referred to as a second actuator.

The flexible container 2966 is disposed in the first chamber 2964 and the first pressure source 2954 is fluidly coupled with the first chamber 2964. The flexible container 2976 is disposed in the second chamber 2974 and the second pressure source 2956 is fluidly coupled with the second chamber 2974. The pump 2950 also includes a conduit 2980 fluidly coupling the flexible container 2966 and the flexible container 2976.

Based on the examples of FIGS. 29A and 29B, the first flexible container 2916, 2966 may be coupled to any container capable of receiving a volume of fluid and returning the volume of the fluid to the flexible container 2916, 2966. For example, the first flexible container 2916, 2966 could be coupled to a syringe that receives fluid from and deposits fluid to the first flexible container 2916, 2966.

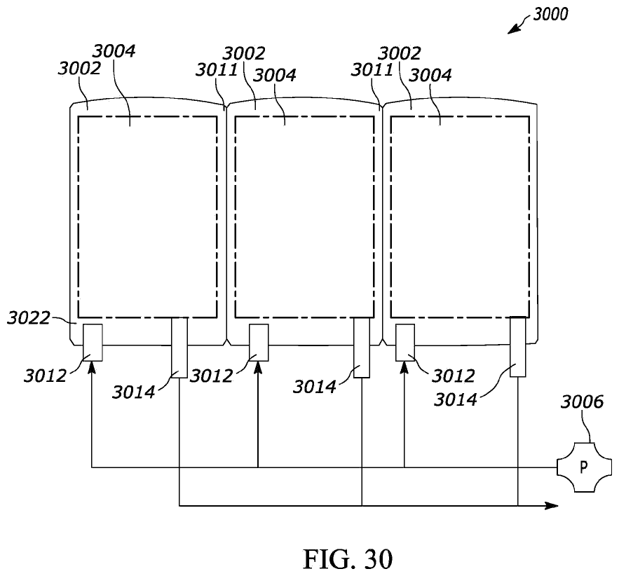

FIG. 30 illustrates a side view of a plurality of reagent reservoirs 3000 that can be used to implement the reagent cartridge 102 of FIG. 1 and/or used to implement the pump 1306 of FIG. 13. The reagent reservoir 3000 may be referred to as a reagent cartridge, a reagent cartridge assembly, or a pump. Each of reagent reservoirs 3000 includes a first flexible container 3002 and a second flexible container 3004. A pressure source 3006 is also shown that may be part of the system 1000 and/or 1300, for example. The reagent reservoirs 3000 are coupled at couplings 3011. In alternative examples, each of the reagent reservoirs 3000 may be separate but fluidly coupled and/or linked to the same pressure source 3006. As shown in FIG. 30, three first flexible containers 3002 and three second flexible containers 3004 are included, but in various other examples, the reagent reservoir 3000 could include more or fewer first and second flexible containers.

The first flexible containers 3002 each include a pressure port 3012. The pressure port 3012 may be coupled with the pressure source 3006 and in fluid communication with the first flexible container 3002 when the reagent reservoirs 3000 are installed in the system 1000, for example. The second flexible container 3004 is disposed in the first flexible container 3002 and includes an aperture 3014. The aperture 3014 may be referred to as a port, an inlet, and/or an outlet. The second flexible container 3004 may contain fluid. The aperture 3014 is externally accessible outside of the first flexible container 3002. Each of the flexible containers 3004 may contain fluid. Fluid may additionally or alternatively flow from a reservoir (e.g., reservoir 1312 or reservoir 1350 of FIG. 13) through the aperture 3014 to the second flexible container 3004. The first flexible container 3002 is pressurized by the pressure source 3006 in operation. When pressurized, the first flexible container 3002 urges the fluid out through the aperture 3014 of the second flexible container 3004.

The corresponding reagent reservoirs 3000 includes an airtight seam 3022 hermetically sealing the first flexible container 3002. The airtight seam 3022 also hermetically seals the second flexible container 3004. In some examples, the airtight seam 3022 also couples the second flexible container 3004 to the first flexible container 3002.

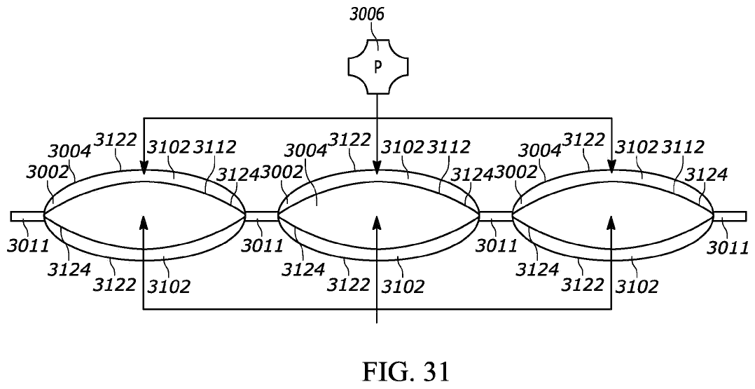

FIG. 31 illustrates a cross-sectional view of the reagent reservoirs 3000 of FIG. 30 containing a first threshold amount of fluid. The reagent reservoir 3000 includes air wells 3102 disposed between the first flexible container 3002 and the second flexible container 3004. The second flexible container 3004 may be made of an oxygen barrier material 3112. In some examples, the oxygen barrier material 3112 is made of an aluminum or an aluminum alloy.

The reagent reservoirs 3000 may be formed using a pair of first sheets 3122 and a second pair of sheets 3124 in the implementation shown. The first sheets 3122 are coupled at the couplings 3011 to form the first flexible containers 3002 and the second sheets 3124 are coupled at the couplings 3011 to form the second flexible containers 3004. The coupling 3011 may be formed by laser welding or hot plate welding and may be referred to as an airtight seal. Any number of sheets may be used to form the reagent reservoirs 3000, however.

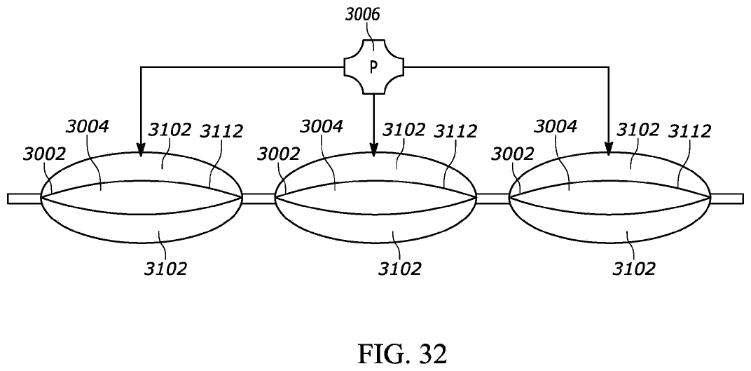

FIG. 32 illustrates a cross-sectional view of the reagent reservoirs 3000 of FIGS. 30 and 31 containing a second threshold amount of fluid. As shown in FIG. 32, the air wells 3102 are pressurized. The pressurized air wells 3102 urged fluid from the second flexible container 3004.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including, “having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

The terms “connect,” “connected,” “contact” “coupled” and/or the like are broadly defined herein to encompass a variety of divergent arrangements and assembly techniques. These arrangements and techniques include, but are not limited to (1) the direct joining of one component and another component with no intervening components therebetween (i.e., the components are in direct physical contact); and (2) the joining of one component and another component with one or more components therebetween, provided that the one component being “connected to” or “contacting” or “coupled to” the other component is somehow in operative communication (e.g., electrically, fluidly, physically, optically, etc.) with the other component (notwithstanding the presence of one or more additional components therebetween). It is to be understood that some components that are in direct physical contact with one another may or may not be in electrical contact and/or fluid contact with one another. Moreover, two components that are electrically connected, electrically coupled, optically connected, optically coupled, fluidly connected or fluidly coupled may or may not be in direct physical contact, and one or more other components may be positioned therebetween.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. An apparatus, comprising:
a reagent cartridge receptacle;
a pressure source; and
a reagent cartridge interface, comprising:
a reagent coupling; and
a pressure coupling fluidly coupled to the pressure source;
a reagent cartridge, comprising
a first flexible container comprising an end and defining a first interior containing reagent;
a second flexible container having an end and defining a second interior, the first flexible container positioned within the second interior; and
a coupling having a first portion coupled to the end of the first flexible container and a second portion coupled to the end of the second flexible container, the coupling comprising a reagent port fluidly coupled to the first interior of the first flexible container and a pressure port fluidly coupled to the second interior of the second flexible container, and
wherein the reagent coupling is to couple with the reagent port to enable reagent to flow out of the first flexible container to the reagent coupling of the reagent cartridge interface and the pressure coupling is to couple with the pressure port to enable the pressure source to change a pressure within the second flexible container to urge the reagent to flow out of the first flexible container.

2. The apparatus of claim 1, wherein the pressure source provides positive pressure.

3. (canceled)

4. The apparatus of claim 1, further comprising a seal carried by the reagent port and a seal carried by the pressure port, wherein the reagent coupling sealingly engages the seal carried by the reagent port and the pressure coupling sealingly engages the seal carried by the pressure port.

5. (canceled)

6. The apparatus of claim 1, further comprising a cover covering the pressure port and the reagent port.

7. The apparatus of claim 6, wherein the cover comprises an impermeable barrier.

8. (canceled)

9. The apparatus of claim 6, wherein the reagent coupling pierces the cover covering the reagent port and the pressure coupling pierces the cover covering the pressure port.

10. The apparatus of claim 1, wherein the coupling further comprises an extension coupled to the reagent port and extends into the first interior of the first flexible container.

11-12. (canceled)

13. The apparatus of claim 1, further comprising an insert positioned within the second interior of the second flexible container and between the second flexible container and the first flexible container.

14-15. (canceled)

16. An apparatus, comprising:
a first flexible container comprising an end and defining a first interior containing reagent;
a second flexible container having an end and defines a second interior, the first flexible container positioned within the second interior; and
a coupling having a first portion coupled to the end of the first flexible container and a second portion coupled to the end of the second flexible container, the coupling comprising a reagent port fluidly coupled to the first interior of the first flexible container and a pressure port fluidly coupled to the second interior of the second flexible container.

17. The apparatus of claim 16, wherein the first flexible container comprises a first pouch bag and the second flexible container comprises a second pouch bag.

18. The apparatus of claim 16, wherein the first flexible container has a neck and the first portion of the coupling is coupled to the neck of the first flexible container and the second flexible container has a neck and the second portion of the coupling is coupled to the neck of the second flexible container.

19. The apparatus of claim 16, wherein the first flexible container comprises a first material and the second flexible container comprises a second material.

20. The apparatus of claim 19, wherein the first material is resistant to air permeability.

21. (canceled)

22. The apparatus of claim 16, wherein the coupling comprises a pressure fluidic line and a reagent fluidic line, the pressure fluidic line extending between the pressure port and the second portion of the coupling and the reagent fluidic line extending between the reagent port and the first portion of the coupling, and wherein the pressure fluidic line extends through the second portion of the coupling to enable a pressure within the second flexible container to change and the reagent fluidic line extends through the first portion and the second portion of the coupling to enable the reagent to flow out of the first flexible container.

23. (canceled)

24. (canceled)

25. (canceled)

26. The apparatus of claim 16, wherein the first portion of the coupling has opposing first side walls that form a first canoe shape and the second portion of the coupling has opposing second side walls that form a second canoe shape.

27-37. (canceled)

38. An apparatus, comprising:
a system, comprising:
a reservoir receptacle to receive a reservoir;
a fluidic interface to be fluidly coupled to the reagent reservoir;
a pump fluidly coupled to the fluidic interface, the pump comprising:
a housing comprising a pressure port;
a flexible container disposed in the housing and including an inlet and an outlet, each of the inlet and the outlet being externally accessible outside of the housing, the inlet being fluidly coupled to the fluidic interface; and
a pressure source coupled with the pressure port and in fluid communication with the housing,
a flow cell receptacle to receive a flow cell and comprising a flow cell interface fluidly coupled to the outlet of the flexible container,
wherein fluid is to flow from the reservoir to the inlet of the flexible container, and
wherein the pressure source is to pressurize the housing and urge the fluid out of the outlet of the flexible container toward the flow cell receptacle.

39. The apparatus of claim 38, wherein the pressure source positively pressurizes the housing.

40. (canceled)

41. The apparatus of claim 38, wherein the pump comprises a coupling comprising the inlet and the outlet and wherein the housing comprises an aperture through which the coupling extends to enable the inlet and the outlet to be externally accessible outside of the housing.

42. (canceled)

43. The apparatus of claim 41, wherein the pump comprises a seal disposed between the coupling and the housing, and wherein the housing comprises a pressure chamber in which the flexible container is disposed and wherein the seal hermetically seals the pressure chamber.

44. (canceled)

45. The apparatus of claim 41, wherein the coupling comprises an extension and the flexible container has an interior that the extension extends into.

46-113. (canceled)
